(19) United States
(12) Patent Application Publication
(10) Pub. No.: US 2019/0296579 A1
(43) Pub. Date: Sep. 26, 2019

(54) WIRELESS POWER FEEDING DEVICE AND WIRELESS POWER FEEDING SYSTEM

(71) Applicants: Kabushiki Kaisha Toshiba, Tokyo (JP); Toshiba Electronic Devices & Storage Corporation, Tokyo (JP)

(72) Inventors: Yasuo Akatsuka, Tokyo (JP); Masahiro Takagi, Tokyo (JP); Eiji Hori, Yokohama (JP)

(21) Appl. No.: 16/121,178

(22) Filed: Sep. 4, 2018

(30) Foreign Application Priority Data
Mar. 23, 2018 (JP) 2018-056128

(51) Int. Cl. H02J 50/10; G06F 3/14

(52) U.S. Cl. CPC H02J 50/10; G06F 3/1446

(57) ABSTRACT

According to an embodiment, a wireless power feeding device includes, in a block, coils for wireless power feeding disposed contiguous to at least two side surface sections. The wireless power feeding device includes a coil section for wireless power feeding including, as a set of pairs, respective coils for wireless power feeding and switches respectively connected in series to the coils for wires power feeding, at least two of the pairs being connected in parallel. The wireless power feeding device includes a power supply section connected to the coil section for wireless power feeding and for causing the wireless power feeding device to operate and a switching section for performing switching of the respective switches of the coil for wireless power feeding. A control section performs control for wireless power feeding.

### CROSS-REFERENCE TO RELATED APPLICATION

This application is based upon and claims the benefit of priority from the prior Japanese Patent Application No. 2018-56128 filed on Mar. 23, 2018; the entire contents of which are incorporated herein by reference.

### FIELD

An embodiment described herein relates generally to a wireless power feeding device and a wireless power feeding system.

### BACKGROUND

Like a publicly-known example disclosed in Japanese Patent Application Laid-Open Publication No. 2016-170398, a plurality of disposed display devices including display screens, the display devices being capable of transferring image data and the like to one another by radio, and a display system including the plurality of disposed display devices exist.

However, the display devices of the publicly-known example generate electric power for the image data transfer and the like using batteries incorporated in the display devices. In this case, if a power supply of any one of the display devices in the display system is disconnected, an image displayed on the display device disappears. As a result, the display system does not function.

### BRIEF DESCRIPTION OF THE DRAWINGS

FIG. 1 is a diagram for explaining an intended usage form of a display system 1 according to an embodiment;

FIG. 2A is a diagram showing various coils and the like disposed on a side surface section side of a display block 2 according to the embodiment;

FIG. 2B is a diagram showing the various coils and the like and a socket disposed on the side surface section side of the display block 2 according to the embodiment;

FIG. 3 is a diagram showing a coil section for wireless power feeding 20 disposed on the side surface section side of the display block 2 according to the embodiment;

FIG. 4 is a diagram of the coil section for wireless power feeding 20 disposed to correspond to respective side surfaces of the display block 2 according to the embodiment;

FIG. 5 is a block diagram showing an internal configuration of the display block 2 for performing wireless power feeding according to the embodiment;

FIG. 6 is a block diagram showing an internal configuration of the display block 2 for performing image data transfer and the like according to the embodiment;

FIG. 7 is a block diagram showing an internal configuration of a smartphone 7;

FIG. 8 is a diagram showing an example of a display block information table TBL1 stored in a memory 56 or a ROM 54 of the smartphone 7 according to the embodiment;

FIG. 9 is a configuration diagram of the display system 1 in which nine blocks 2 for performing transfer of image data and the like are disposed such that a display surface 1a is formed in a square shape according to the embodiment;

FIG. 10 is a flowchart showing an example of a flow of processing of an image display application program executed in the smartphone 7 according to the embodiment;

FIG. 11 is a diagram showing a state during initialization of a state information table TBL2 of the block 2 according to the embodiment;

FIG. 12 is a diagram showing search states and values of state variables that an adjacent number can take written in the state information table TBL2 according to the embodiment;

FIG. 13 is a flowchart showing an example of a flow of processing executed when power supplies of the respective blocks 2 are turned on according to the embodiment;

FIG. 14 is a flowchart showing an example of a flow of search request/response command processing in S3 in the respective blocks 2 according to the embodiment;

FIG. 15 is a flowchart showing an example of the flow of the search request/response command processing in S3 in the respective blocks 2 according to the embodiment;

FIG. 16 is a flowchart showing an example of the flow of the search request/response command processing in S3 in the respective blocks 2 according to the embodiment;

FIG. 17 is a flowchart showing an example of the flow of the search request/response command processing in S3 in the respective blocks 2 according to the embodiment;

FIG. 18 is a flowchart showing an example of the flow of the search request/response command processing in S3 in the respective blocks 2 according to the embodiment;

FIG. 19 is a flowchart showing an example of the flow of the search request/response command processing in S3 in the respective blocks 2 according to the embodiment;

FIG. 20 is a diagram showing a state of the state information table TBL2 after a block 2(1) receives a search request command SC from the smartphone 7 in a transmitting and receiving section 40A and processing in S14 is executed according to the embodiment;

FIG. 21 is a diagram showing a state of the state information table TBL2 at the time when a transmitting and receiving section 40B is set as an output transmitting and receiving section first by execution of processing in S15 in the block 2(1) according to the embodiment;

FIG. 22 is a diagram showing a state of the state information table TBL2 in the block 2(1) that transmits a search response RC to a block (8) according to the embodiment;

FIG. 23 is a diagram showing a path information string PIS included in the search response RC that a block (1) transmits to the block (8) according to the embodiment;

FIG. 24 is a diagram showing a state of the state information table TBL2 of the block (8) at the time when the block (8) transmits the search response RC to a block 2(7) according to the embodiment;

FIG. 25 is a diagram showing a state of the state information table TBL2 after the block 2(1) receives the search response RC from a block 2(2) according to the embodiment

FIG. 26 is a diagram showing a state of the state information table TBL2 at the time when the block 2(1) transmits the search request command SC to a block 2(9) according to the embodiment;

FIG. 27 is a diagram showing a state of the state information table TBL2 after the block 2(1) receives the search response RC from the block 2(9) according to the embodiment;

FIG. 28 is a diagram showing a state of the state information table TBL2 after the block 2(1) receives the search response RC from a block 2(8) according to the embodiment;

FIG. 29 is a diagram showing the path information string PIS included in the search response RC transmitted from the block 2(1) to the smartphone 7 according to the embodiment;

FIG. 30 is a diagram showing a flow of the search request command SC in the display system 1 according to the embodiment;

FIG. 31 is a flowchart showing an example of a flow of adjacency matrix creation processing for generating block arrangement information in S3 according to the embodiment;

FIG. 32 is a flowchart showing an example of a flow of adjacency matrix initialization processing according to the embodiment;

FIG. 33 is a diagram showing an example of an adjacency matrix table generated in S112 according to the embodiment;

FIG. 34 is a diagram showing a part of an adjacency matrix table TBL3 including information concerning a connection relation among the blocks 2 as a result of processing in FIG. 31 according to the embodiment;

FIG. 35 is a configuration diagram of the display system 1 in which the nine blocks 2 for performing wireless power feeding are disposed such that the display surface 1a is formed in a square shape according to the embodiment;

FIG. 36 is a configuration diagram of the display system 1 in which the nine blocks 2 for performing wireless power feeding are disposed such that the display surface 1a is formed in a square shape according to the embodiment;

FIG. 37 is a diagram showing a storable housing incorporating a coil for wireless power feeding provided on a rear surface side of the block 2;

FIG. 38 is a diagram in which a charger and a DC/AC inverter is added to the block diagram of FIG. 5;

FIG. 39 is a diagram showing a data table for battery residual power management;

FIG. 40 is a diagram showing three blocks 2 not including display sections 34;

FIG. 41 is a diagram showing one block not including the display section 34 disposed between two display systems apart from each other;

FIG. 42 is a diagram in which a modulation/demodulation circuit is further added to the block diagram of FIG. 38;

FIG. 43 is a timing chart of voltages applied to respective coils for wireless power feeding for disposition search for respective blocks configuring the display system 1 and ON and OFF of respective switches;

FIG. 44 is a diagram of explanation concerning disposition of access points and stations in the smartphone 7 and the respective blocks 2 configuring the display system 1;

FIG. 45 is a diagram of explanation concerning the disposition of the access points and the stations in the smartphone 7 and the respective blocks 2 configuring the display system 1;

FIG. 46 is a diagram in which information displayed on the display sections 34 for disposition search for the respective blocks 2 configuring the display system 1 is photographed by the smartphone 7;

FIG. 47A is a diagram showing a configuration in which a side surface section 3 of the block 2 is improved;

FIG. 47B is a diagram showing the configuration in which the side surface section 3 of the block 2 is improved; and

FIG. 48 is a diagram showing a state in which lid sections 143 projecting from two side surface sections 3 of two adjacent blocks are coupled to each other.

### DETAILED DESCRIPTION

According to an embodiment, a wireless power feeding device including: a coil section for wireless power feeding including, as pairs, coils for wireless power feeding provided on at least two side surface section sides of the wireless power feeding device and switches connected in series to the coils for wireless power feeding, at least two of the pairs being connected in parallel; a power supply section connected to the coil section for wireless power feeding and for causing the wireless power feeding device to operate; a switching section for performing switching of ON and OFF of the respective switches; and a control section configured to perform control for wireless power feeding of the wireless power feeding device is provided.

The embodiment is explained below referring to the drawings.

### (Configuration)

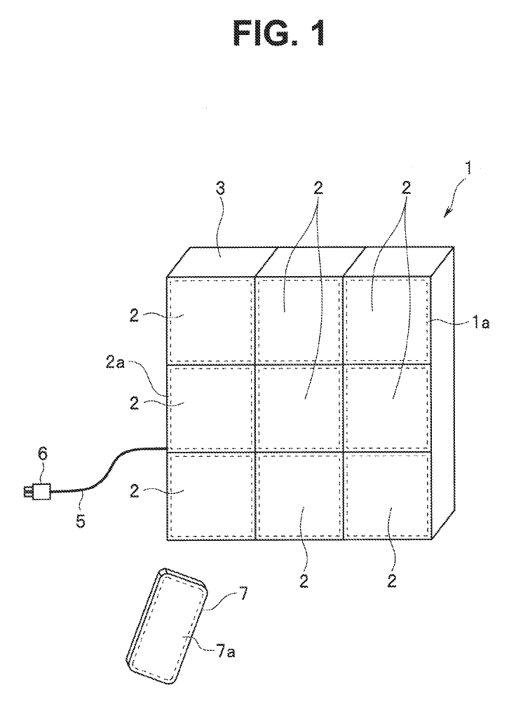

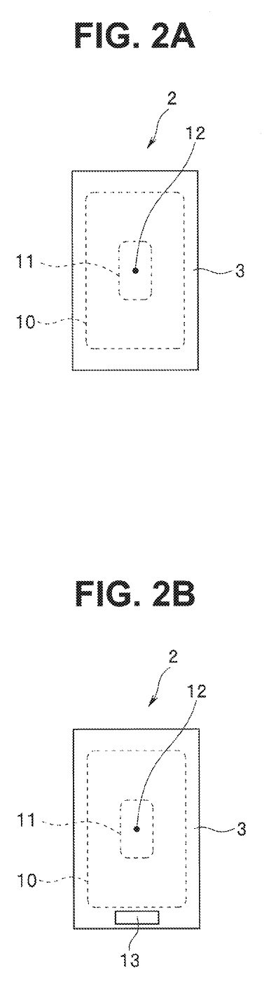

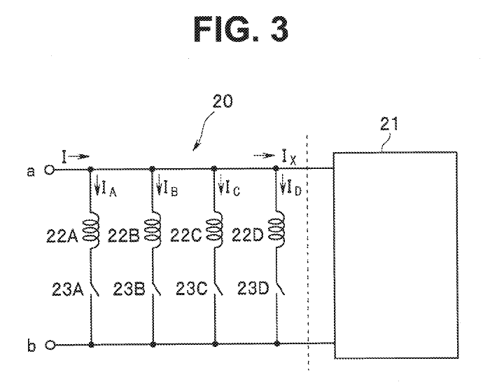

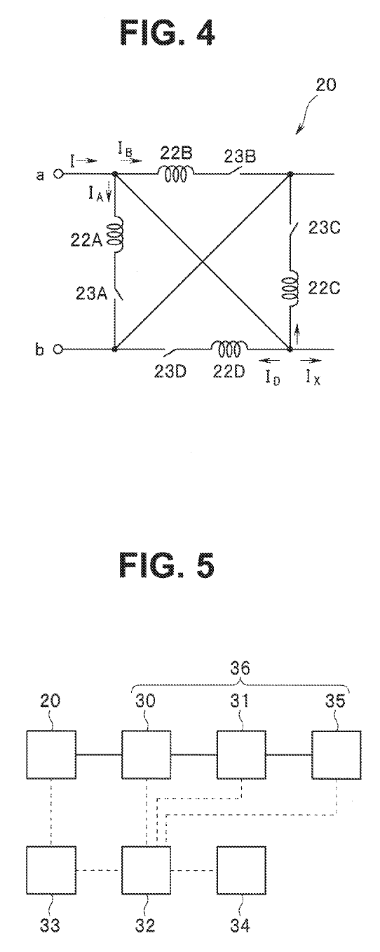

FIG. 1 is a diagram for explaining an intended usage form of a display system 1 that performs display of an image and the like according to the embodiment (hereinafter, the display system 1). FIG. 2A is a diagram showing various coils disposed on side surface section 3 sides of respective display blocks 2 (hereinafter, the blocks 2) configuring the display system 1 according to the embodiment. FIG. 2B is a diagram showing a socket in addition to the various coils. FIG. 3 is a diagram showing a coil section for wireless power feeding 20 disposed in the block 2. FIG. 4 is a diagram showing a case in which respective coils 22A to 22D of the coil section for wireless power feeding 20 shown in FIG. 3 are respectively disposed on side surface sides of the blocks 2.

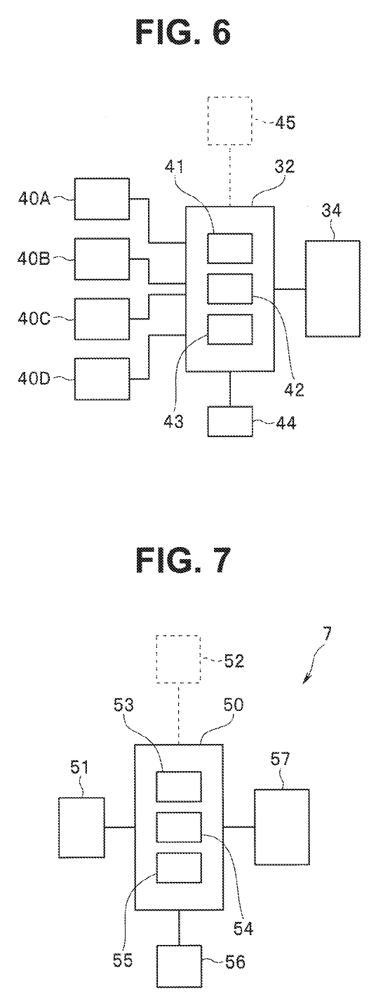

FIG. 5 is a block diagram showing an internal configuration of the block 2 for performing wireless power feeding. FIG. 6 is a block diagram showing an internal configuration of the block 2 for performing data communication of an image and the like. Note that in the block 2, in addition to a control section 32 and a display section 34, all other block circuits shown in respective figures excluding the control section 32 and the display section 34 shown in FIGS. 5 and 6 are combined and incorporated FIG. 7 is a diagram showing a circuit configuration of a smartphone 7.

The respective blocks 2 shown in FIG. 1 have a rectangular parallelepiped or a cube shape, for example, a shape of display surfaces 2a serving as principal planes of which is, for example, a square, and are housings including four side surface sections 3 on side surface sides of the blocks 2. Note that the shape of the display surfaces 2a may be other polygonal shapes (a triangle, a pentagon, a hexagon, etc.).

A display surface 1a of the display system 1 is one display surface including a plurality of display surfaces 2a formed by disposing predetermined side surface sections 3 of these blocks 2 to be closely attached or contiguous. In the following explanation, disposing the side surface sections 3 to be closely attached or contiguous is explained using a word “coupling”.

The housing of the block 2 is made of, for example, plastic-based resin. Other materials may be used according to a size and required strength of the block 2.

On a rear side of the side surface section 3 of the block 2 shown in FIG. 2A, a coil for wireless power feeding 10 for wireless power feeding indicated by dotted line is disposed. On an inner side of the side surface section 3, a proximity wireless communication, for example, NFC (near field communication) coil 11 for data communication is disposed. Note that centers of the two coils coincide with a center portion 12 of the side surface section 3.

As shown in FIG. 2B, a socket 13 is provided in one of the respective side surface sections 3 of the block 2. The socket may be provided in at least one block among respective blocks configuring the display system 1.

Consequently, for example, electric power from a 100 V AC power supply (not shown) is supplied to an inside of the block 2 via an outlet 6, a power supply wire 5, and the socket as shown in FIG. 1. Note that although not shown in FIG. 1, an AC/AC converter for stepping down a 100 V AC voltage to a predetermined AC voltage may be provided in a predetermined part of the power supply wire 5 according to an intended usage.

A coil section for wireless power feeding 20 shown in FIG. 3 is configured by respective pairs of coils for wireless power feeding 22A to 22D and switches 23A to 23D respectively connected in series to the coils for wireless power feeding 22A to 22D. The respective pairs are connected in parallel to one another.

The coils for wireless power feeding 22A to 22D are disposed contiguous to rear sides of the respective side surface sections 3 as shown in FIG. 2A. Wiring end portions a and b of the coil section for wireless power feeding 20 are connected to a terminal of the socket 13 shown in FIG. 2B.

End portions on an opposite side of the wiring end portions a and b shown in FIG. 3 are connected to an internal circuit 21 of the block 2. Consequently, for example, a voltage of the 100 V AC power supply for causing a system of the block 2 to operate is applied to the internal circuit 21. Electric power is supplied to the internal circuit 21 of the block 2 and the system of the block 2 starts. Note that as explained below, electric power is supplied to the internal circuit 21 by turning on at least one or more of the switches 23A to 23D according to the number of other blocks 2 coupled to the block 2.

FIG. 4 is an equivalent circuit of the coil section for wireless power feeding 20 shown in FIG. 3. Such a disposition relation is obtained when the respective coils for wireless power feeding 22A to 22D are disposed contiguous to the respective side surface sections 3 of the block 2. Consequently, cross wiring (one end of a first wire is connected between the coils for wireless power feeding 22A and 22B and the other end is connected to the other ends of the coils for wireless power feeding 22C and 22D and one end of a second wire is connected between the switches 23A and 23B and the other end is connected between the switches 23C and 23D) is naturally formed. Note that although the coils for wireless power feeding 22A to 22D are disposed as shown in FIGS. 2A and 2B, the respective switches 23A to 23D do not need to be disposed contiguous to the respective side surface sections 3 and may be disposed in positions apart from the respective side surface sections 3.

FIG. 5 is a circuit block provided in the block 2 in order to perform wireless power feeding from a certain block 2 to the other blocks 2 coupled to the certain block 2. The circuit block is a part of the internal circuit 21.

The coil section for wireless power feeding 20 is connected to an input end of an AC/DC converter 30. An output end of the AC/DC converter 30 is connected to a charger 31.

Note that although not shown on FIG. 5, the output end of the AC/DC converter 30 may be of multiple outputs. Consequently, when electric power is supplied for system operation of a wireless power feeding device and surplus power exists in electric power supplied from the AC/DC converter 30, as in the ease of a PC, a battery 35 is charged through the charger 31.

It goes without saying that, when electric power supplied from the coil section for wireless power feeding 20 is absent or insufficient (when power failure or the like occurs), electric power is supplied from the battery 35 for the system operation of the wireless power feeding device.

It is assumed that the charger 31 has other various functions necessary for the system operation in addition to a boosting function. The AC/DC converter 30 or the charger 31 and the battery 35 function as a power supplying section 36 for the system operation each other.

As indicated by dotted lines, the control section 32 performs control on the AC/DC converter 30, the charger 31, and the battery 35 in addition to control of a switching section 33 for switching ON and OFF of the respective switches 23A to 23D of the coil section for wireless power feeding 20 and the display section 34 configured to drive a liquid crystal panel (besides, an organic EL, an LED, or the like) for displaying an image.

Note that the switching section 33 is, for example, a semiconductor switch. Other switches may be selected according to an intended usage.

FIG. 6 is a circuit block for transferring data Such as an image from a certain block 2 to another block 2 coupled to the certain block 2 and performing disposition search (explained below) for recognizing where the respective blocks 2 themselves configuring the display system 1 are disposed. The control section 32 explained referring to FIG. 5 includes a central processing unit (hereinafter referred to as CPU) 41, a ROM 42, and a RAM 43. Further, a memory 44, which is a nonvolatile memory such as a flash memory, is connected to the control section 32. In the RAM 43, a state information table TBL2 explained below is stored and information such as a coupling state to other blocks is stored.

The memory 44 is a memory having a relatively large capacity. As explained below, the memory 44 can store a large number of image data of still images. When it is desired to save a large number of moving images having a large capacity, a storage capacity of the memory 44 may be increased according to the capacity.

The CPU 41 can read out a computer program stored in the ROM 42, expand the computer program in the RAM 43, and execute the computer program. A processing program and table information explained below are stored in the ROM 42 in advance.

Four transmitting and receiving sections 40A to 40D are circuits for the proximity wireless communication, for example, circuits for the NFC communication. The transmitting and receiving sections 40A to 40D respectively include coils for NFC 11 disposed contiguous to the respective side surface sections 3 shown in FIGS. 2A and 2B.

Consequently, in a state in which certain side surface sections 3 of the respective blocks 2 are coupled to certain side surface sections 3 of other blocks 2, the coil for NFC 11 disposed contiguous to one side surface section 3 and the coil for NFC 11 disposed contiguous to tie other side surface section 3 are contiguous to each other. Therefore, the proximity wireless communication can be performed between two blocks 2.

In this case, for example, the two blocks can communicate with each other at a distance within several centimeters. Note that a communication distance may be adjusted according to a size of the block 2.

When a certain block 2 is coupled to another block 2, communication is possible only between two transmitting and receiving sections 40 closely coupled two side surface sections 3. Transmission and reception of a command, image data, and the like is possible between the two transmitting and receiving sections 40.

As explained below, if the smartphone 7 includes a transmitting and receiving section 51 for the proximity wireless communication (NFC) same as the respective transmitting and receiving sections 40, the respective transmitting and receiving sections 40 can perform the proximity wireless communication with the smartphone 7. Note that a wireless communication section 45 that performs short-distance wireless communication, for example, WiFi communication with the control section 32 may be provided.

The control sections 32 of the respective blocks 2 have information for associating the respective side surface sections 3 and the transmitting and receiving sections 40A to 40D disposed near the respective side surface sections 3. For example, one side surface section 3 of the block 2 may be associated with the transmitting and receiving section 40A. The side surface section 3 present in a position 90° clockwise from the side surface section 3 may be associated with the transmitting and receiving section 40B. For example, these kinds of associated information are written in advance in the ROMs 42 of the respective control sections 32 during manufacturing of the respective blocks 2.

The respective blocks 2 are configured by being combined with the circuit blocks shown in FIGS. 5 and 6 (note that naturally the control section 32 and the display section 34 common to the respective figures are respectively one control section and one display section).

Note that although not shown in the respective blocks 2, for example, a power switch not projecting from a rear surface on an opposite side of the display surface 2a may be provided on the rear surface. The respective circuits such as the control sections 32 configuring the systems of the respective blocks 2 may be started with power supply from the battery 35 by turning on the power switch.

As shown in FIG. 7, the smartphone 7 includes a control section 50, a memory 56, a display section 52, a wireless communication section 57, and a transmitting and receiving section 51. Note that ON and OFF of the power switches of the respective blocks 2 may start, according to a system start signal from the smartphone 7 to the block 2 selected out of the respective blocks 2 configuring the display system, the system of the selected block 2. In this way, the start signal may be transmitted from a block to an adjacent block to start all blocks in order.

The control section 50 includes a CPU 53, a ROM 54, and a RAM 55.

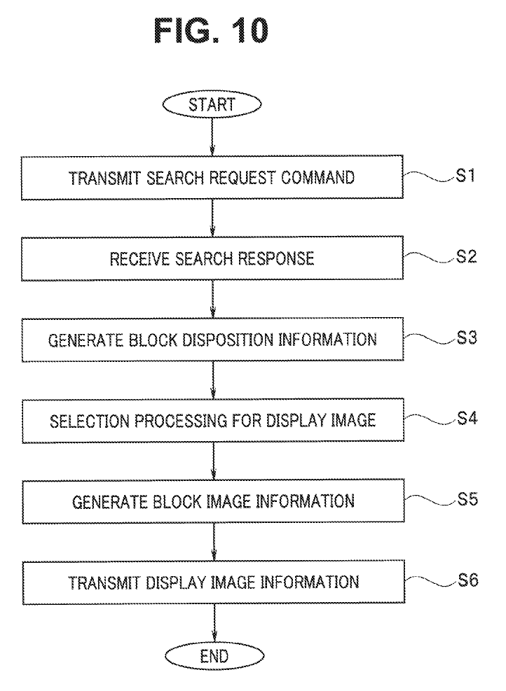

The CPU 53 can read out computer programs stored in the ROM 54 and the memory 56, expand the computer programs on the RAM 55, and execute the computer programs in the memory 56 or the ROM 54, an image display application program (FIG. 10) for causing the display system 1to display an image is stored.

Further, in the memory 56 or the ROM 54; a display block information table TBL1 used in the image display application program is also stored.

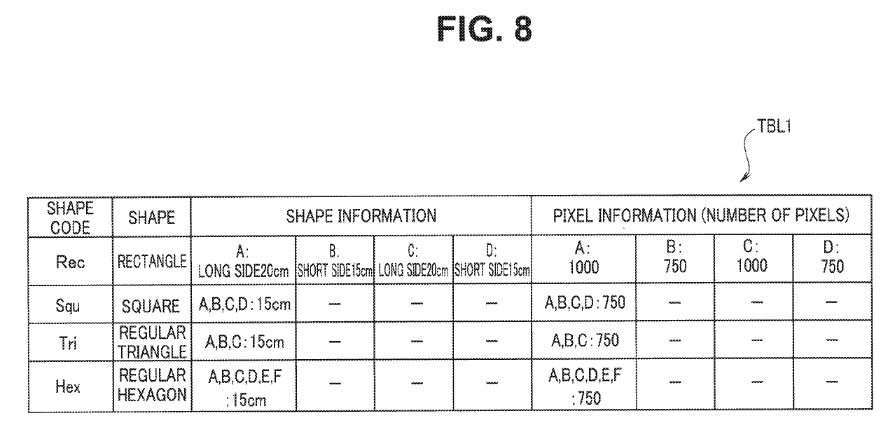

FIG. 8 is a diagram showing an example of the display block information table TBL1 stored in the memory 56 or the ROM 54 of the smartphone 7. The display block information table TBL1 includes a shape code indicating a shape of a portion of the display surface 2a of the block 2, shape information corresponding to the shape code, and pixel information. Note that in the shape information, respective sides corresponding to a shape such as a square of the display surface 2a are shown.

Information concerning lengths of the respective sides is registered for each shape code. In FIG. 5, Rec, Squ, Tri, and Hex are shape codes and respectively mean a rectangle, a square, a regular triangle, and a regular hexagon. For example, information indicating that, concerning the shape code (Rec) of the rectangle, a long side is 20 cm and a short side is 15 cm and, concerning the regular triangle (Tri), respective sides are 15 cm is registered in the display block information table TBL1.

Further, pixel information of the respective blocks is registered for each shape code. When a shape is the rectangle (Rec), for example, pixel information indicating that one long side includes 1000 pixels, one short side includes 750 pixels, the other long side includes 1000 pixels, and the other short side includes 750 pixels is registered in the display block information table TBL1.

The memory 56 connected to the CPU 53 is a nonvolatile memory such as a flash memory. The memory 56 is a memory having a relatively large capacity. As explained below, the memory 56 can store image data of a still image or a moving image.

The display section 52 is attached with a touch panel. A user can give instructions for execution of various commands to the CPU 53 by touching a display panel present on a display surface 7a of the display section 52.

The wireless communication section 57 is a circuit block for a telephone call and data communication and is a circuit for communication with a telephone line and a communication line of the smartphone 7.

The transmitting and receiving section 51 is a transmitting and receiving section for the proximity wireless communication (NFC) and is a circuit capable of communicating with the transmitting and receiving sections 40A to 40D of the respective blocks 2.

In the smartphone 7, when the image display application program is executed, a predetermined command, that is, a block disposition search request command SC is transmitted to the block 2.

Note that display blocks having various shapes such as an isosceles triangle and a regular pentagon besides the rectangle, the square, the regular triangle, and the regular hexagon shown in FIG. 8 may be present. That is, in the display system 1, at least one of a plurality of blocks may have a display surface having a shape different from a shape of the other blocks.

In the display system 1 in the embodiment, even the blocks having the different shapes can be coupled. The user can also construct a system including a display surface having a desired shape using blocks having various shapes.

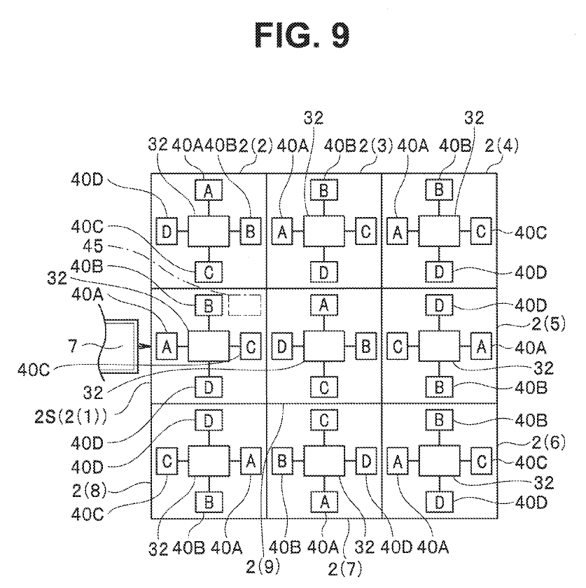

FIG. 9 is a configuration diagram planarly showing the display system 1 in which the display surface 2a is formed by coupling nine square blocks 2 and showing the transmitting and receiving sections 40A to 40D and the control sections 32 connected to the transmitting and receiving sections 40A to 40D in internal configurations of the respective blocks 2. In FIG. 9, the respective blocks 2 are square. The nine blocks 2 are indicated as 2(1), 2(2), 2(3), 2(4), 2(5), 2(6), 2(7), 2(8), and 2(9) to be distinguished from one another in the following explanation. In particular, the block 2(1) is also a start block 2S because the block 2(1) performs the proximity wireless communication with the smartphone 7. In FIG. 9, respective positions of the transmitting and receiving sections 40A to 40D corresponding to the respective four side surface sections 3 of the respective blocks 2 are indicated by positions of signs A to D. A disposition position relation of these signs is common in all the blocks 2. That is, a position of the sign B is in a position rotated 90° in a clockwise direction with respect to the sign A. The signs C and D are also present in rotated positions. The wireless communication section 45 of WiFi or the like explained referring to FIG. 6 may be disposed in the start block 2S. When the wireless communication section 45 is disposed, information communication can be performed with the start block 2S from a separated position without bringing the smartphone 7 close to the side surface section 3 of the start block 2S.

Action of the smartphone 7 and the display system 1 is explained using the configuration of the display system 1 shown in FIG. 9 as an example.

### (Operation in the Smartphone 7)

FIG. 10 is a flowchart showing an example of a flow of processing of the image display application program executed in the smartphone 7.

Note that to cause the display system 1 to display an image, the user turns on the power supplies of the respective blocks 2 configuring the display system 1.

The processing in FIG. 10 is executed when the user starts the image display application program in the smartphone 7. The image display application program is a computer program for causing the display system 1 to display a desired image. When the image display application program is executed, various command buttons are displayed on the display surface 7a, which is a screen of the smartphone 7. The user can cause the display system 1 to execute various kinds of processing by touching a desired command button out of a displayed plurality of command buttons.

When the user touches a displayed disposition search command transmission button, the processing shown in FIG. 10 is executed. The CPU 53 transmits a block disposition search request command (hereinafter referred to as search request command) SC (step (abbreviated as S below) 1). More specifically, the user brings the smartphone 7 close to any block 2 in the display system 1, touches the disposition search request command transmission button on the display surface 7a, and causes the display system 1 to execute transmission processing for the search request command SC. In the case of FIG. 9, the smartphone 7 is brought close to the block 2(1) and the search request command SC is transmitted. The search request command SC is transmitted from the transmitting and receiving section 51. That is, the smartphone 7 is a transmission device configured to transmit the search request command SC, which is predetermined information, to one of the plurality of blocks 2, which are respectively wireless power feeding devices.

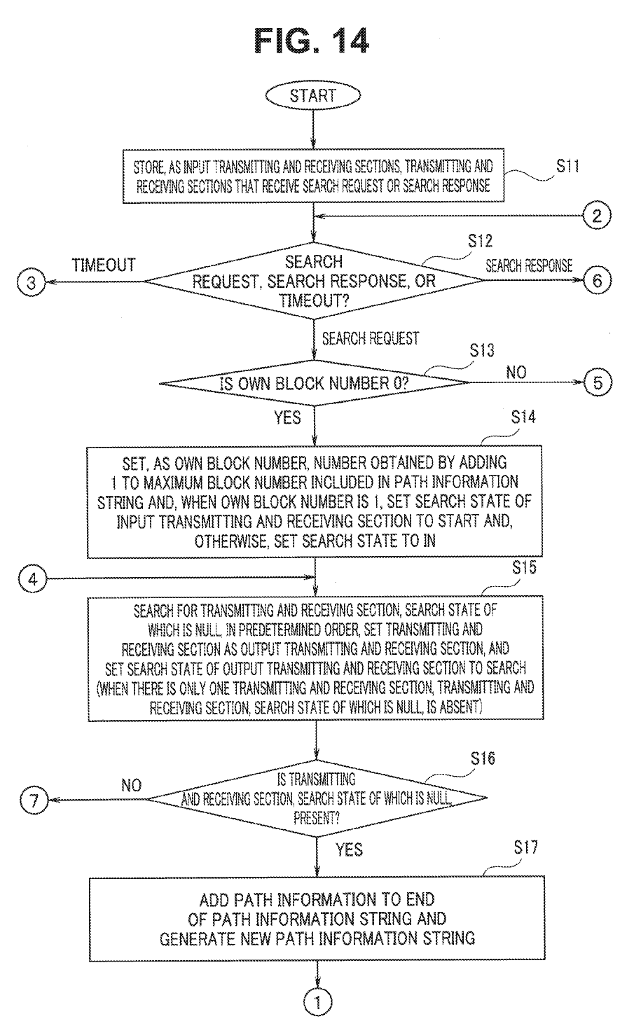

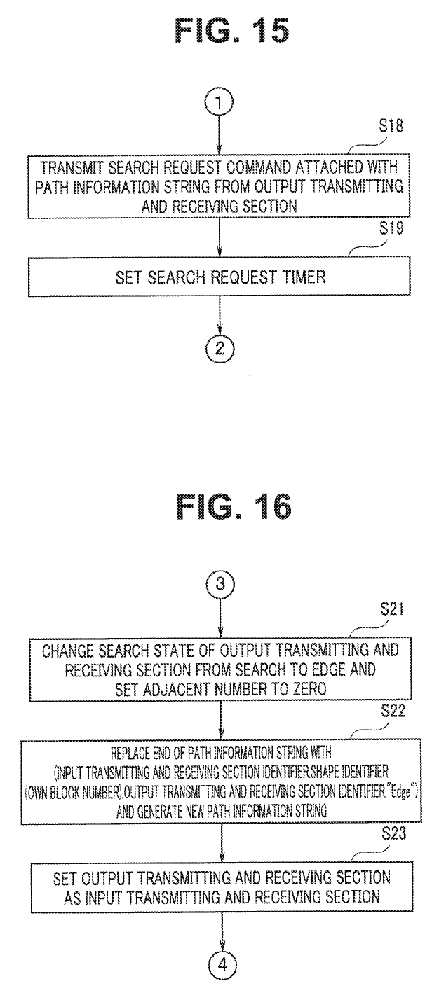

In the case of FIG. 9, the search request command SC is received by the transmitting and receiving section 40A closest to the smartphone 7 among the transmitting and receiving sections 40A to 40D of the block 2(1) in a left side center. The search request command SC is a command for causing the block 2(1) to execute search request/response command processing (FIGS. 14 to 19) in order to acquire disposition information of the plurality of blocks 2 configuring the display system 1, that is, block disposition information.

The search request command SC is received by one transmitting and receiving section 40 of the block 2(1), in the case of FIG. 9, the transmitting and receiving section 40A of the block 2(1) from the smartphone 7 through the proximity wireless communication (NFC).

A path information string PIS is added to the search request command SC as explained below. However, the path information string PIS is not added to the search request command SC transmitted from the smartphone 7 first in S1. That is, in S1, the search request command SC not including the path information string PIS is transmitted.

The block 2(1) (hereinafter referred to as start block 2S as well), which receives the search request command SC including the empty path information string PIS, executes search request/response command processing for obtaining coupling state information of the plurality of blocks 2 configuring the display system 1. Note that as explained below, the search request/response command processing is executed in the respective blocks 2 including the start block 2S. The search request/response command processing is explained below (FIGS. 14 to 19).

After the transmission of the search request command SC, the CPU 53 receives a block disposition search response (hereinafter referred, to as search response) RC including coupling state information among the plurality of (nine) blocks 2 configuring the display system 1 from the start block 2S (S2). The path information string PIS indicating the coupling state information among the blocks 2 is included in the search request command SC and the search response RC transmitted and received among the blocks 2.

The search response RC is the search request command SC returned in response to the transmitted search request command SC. Therefore, as explained below, the CPU 53 can obtain, from the path information string PIS included in the search response RC received from the start block 2S, block disposition information configured from all the blocks 2 configuring the display system 1.

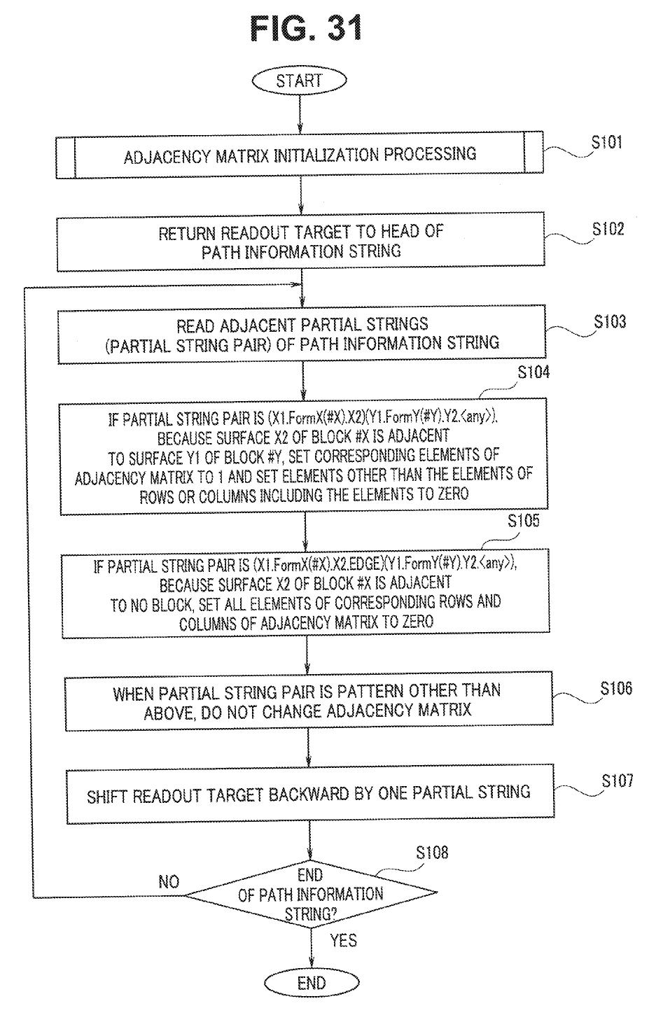

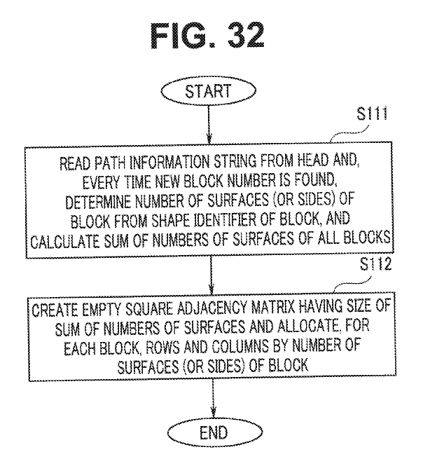

The CPU 53 generates an adjacency matrix through adjacency matrix creation processing on the basis of the path information string PIS included in the received search response RC and the display block information table TBL1 explained above and generates block disposition information of the display system 1 (S3). The adjacency matrix creation processing in S3 is explained below (FIGS. 31 and 32).

The block disposition information includes information concerning an overall shape and a size of the display surface 1a of the display system 1 and a shape and a size (including the number of pixels) of each of the plurality of blocks 2 configuring the display surface 1a

Note that at this time, information concerning a shape and a size of the display surface 1a of the display system 1 may be displayed on the screen 7a of the smartphone 7.

The CPU 53 executes selection processing for a display image (S4).

When the user instructs transmission processing for the search request command SC, the CPU 53 acquires the path information string PIS from the start block 2S after a predetermined time period. Therefore, the CPU 53 displays, on a screen 3a of the smartphone 7, completion of the generation of the block disposition information indicating the coupling state of the plurality of blocks, a message for urging selection of an image that should be displayed, or the like.

By receiving the result, the user can select or designate, out of images stored in the memory 56 of the smartphone 7, an image that the user desires to cause the display system 1 to display (hereinafter referred to as display image) (S4).

Note that after S3 the selection or the designation of the image is performed. However, the selection or the designation of the image that should be displayed on the display system 1 may be performed by the user in advance before the execution of the processing shown in FIG. 10.

When the display image is selected and determined, the CPU 53 generates, on the basis of the block disposition information generated in S3, image information for each block (hereinafter referred to as block image information) from the selected display image (S5).

The block image information is display image data for each block and is image information of the display image that the CPU 53 causes the respective blocks 2 to display in order to cause the display surface 1a of the display system 1 to display the display image.

The CPU 53 transmits display image information including a generated plurality of kinds of block image information to the start block 2S in association with information concerning own block numbers (explained below) temporarily generated in the respective blocks 2 (S6). That is, the block image information for each block 2 is generated. The respective kinds of block image information are transmitted together with the information concerning the own block numbers.

As explained below, when receiving the display image information, the start block 2S determines on the basis of the simultaneously transmitted block numbers whether the block image information included in the display image information is a block image that the start block 2S should display. When the block image information is block image information addressed to the start block 2S, the start block 2S outputs the block image information to the display section 34 and displays the block image information. When the block image information is not block image information addressed to the start block 2S, the start block 2S transfers the received display image information to another adjacent block 2.

The respective blocks 2 acquire, on the basis of the information concerning the own block numbers, block image information concerning images that the blocks 2 should display and display the images on the display surfaces 2a As a result, an image selected by the user is displayed on the display surface 1a of the display system 1. Note that the blocks 2 may temporarily save image information addressed to the blocks 2 and image information of the other blocks in the RAMs 43 or the memories 44. If the blocks 2 are configured to display images other than the image addressed to the blocks 2, for example, the display system 1 can be used for many uses such as a digital signage.

### (Processing in the Respective Blocks)

Before processing in the respective blocks is explained, a state information table TBL2 generated in the RAMs 43 of the respective blocks 2 is explained.

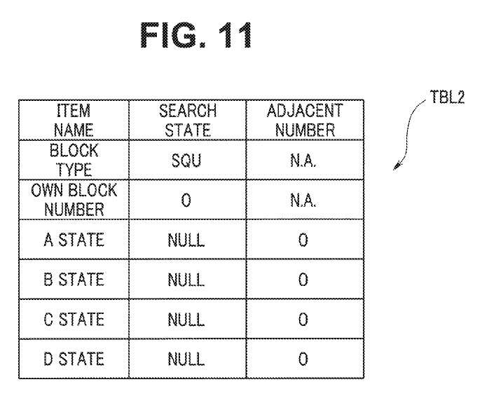

FIG. 11 is a diagram showing a state during initialization of the state information table TBL2 of the block 2. The state information table TBL2 is a table generated during initialization of the block 2 and capable of storing information of search states and adjacent numbers concerning a block type, an own block number, and respective sides.

In a field of the search state of the block type, a shape code of a block is stored. In a field of the search state of the own block number, a number of the block, that is, a block number is stored. The shape code of the block and the number of the block are respectively stored in the field of the search state of the block type and the field of the search state of the own block number. However, the shape code of the block and the number of the block may be stored in different fields or a different table.

In the fields of the search state of the respective sides, search state information is stored.

In the fields of the adjacent number of the respective sides, numbers of adjacent blocks are stored.

Note that in FIG. 11 “N.A.” is an abbreviation of “NOT APPLICABLE”.

When the power supplies are turned on, the respective blocks 2 execute initialization processing, generate the state information table TBL2, and initialize content of the state information table TBL2.

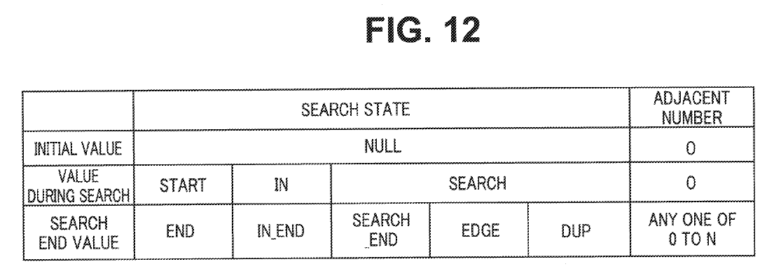

FIG. 12 is a diagram showing values of variables of states that the search state and the adjacent number written in the state information table TBL2 can take.

An initial value of the search state is “NULL”. The search state is any one of “START”, “IN”, and “SEARCH” during a search. A search end value of the search state is any one of “END”, “IN_END”, “SEARCH_END”, “EDGE”, and “DUP”.

An initial value and a value during search of the adjacent number is “0”. A search end value of the adjacent number is any value between “0” and “N”. N is an integer.

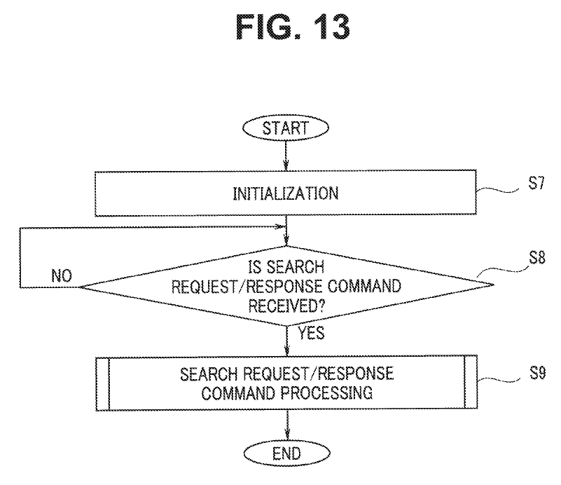

FIG. 13 is a flowchart showing an example of a flow of processing executed when the power supplies of the respective blocks 2 are turned on.

When the power supplies of the respective blocks 2 are turned on, the CPUs 41 read out a predetermined initialization program from the ROMs 42 and execute initialization of the respective circuits in the blocks 2 (S7).

During the initialization, the CPUs 41 of the respective blocks 2 generate the state information table TBL2 explained above shown in FIG. 11 and stare the state information table TBL2 in the RAMS 43.

The CPUs 41 read out the shape codes indicating the shapes of the blocks stored in the ROMs 42 and store the shape codes in the field of the search state of the item of the block type of the state information table TBL2. Further, the CPUs 41 generate items of states corresponding to the respective sides according to the block type and store “NULL” in the field of the search state. The CPUs 41 store “0” in the other fields of the other items.

Therefore, as shown in FIG. 11, during the initialization of the state information table TBL2 of the respective blocks 2, “SQU” corresponding to the shape code is written in the field of the search state of the block type, items of states of a side A to a side D of a square corresponding to the four transmitting and receiving sections 40A to 40D are generated, and “NULL” is written in the fields of the search states of the respective states.

When the initialization ends, the CPUs 41 determine Whether the search request command SC or the search response RC is received (S8). The search response RC is a command returned in response to the transmitted search request command SC and has the same configuration as the search request command SC.

If the search request command SC or the search response RC is not received (NO in S8), the CPUs 41 perform no processing. If the search request command SC and the search response RC are received (YES in S8), the CPUs 41 read out a computer program for search request/response command processing, which is a processing program for the search request command SC and the search response RC, from the ROMs 42 and execute the computer program (S9).

### (Search Request/Response Command Processing in the Respective Blocks 2)

FIGS. 14 to 19 are flowcharts showing an example of a flow of the search request/response command processing in S9 in the respective blocks 2.

When the blocks 2 receive the search request command SC or the search response RC, the CPUs 41 store, in the RAMS 43, indication that transmitting and receiving sections that receive the search request command SC or the search response RC are input transmitting and receiving sections (S11). In the block 2(1) that receives the search request command SC, the transmitting and receiving section 40A is the input transmitting and receiving section.

The CPUs 41 determine whether the received command is the search request command SC or the search response RC or whether a timeout signal of a set timer explained below is generated (S12).

In S12, no processing is performed until the search request command SC or the search response RC is received or the set timer times out.

When the received command is the search request command SC, the CPUs 41 determine whether the own block numbers in the state information table TBL2 are “0” (S13). Immediately after the initialization, the own block numbers in the state information table TBL2 of the respective blocks 2 are “0”.

When the own block numbers are “0” (YES in S13), the CPUs 41 set numbers obtained by adding 1 to a maximum block number included in the path information string PIS as the own block numbers and set search states of the input transmitting and receiving sections to START when the own block numbers are 1 and otherwise set the search states to IN (S14). Therefore, processing in S14 configures an identification-information generating section configured to generate own block numbers, which are identification information of the own blocks, on the basis of information included in the received search request command SC.

In the case of the display system 1 shown in FIG. 9, the smartphone 7 transmits the search request command SC in S1 explained above. The block 2(1) of the display system 1 receives the search request command SC in the transmitting and receiving section 40A. According to the initialization, the own block number in the state information table TBL2 of the, block 2(1) is “0”.

Because the own block number is “0” (YES in S13), the CPU 41 of the block 2(1) writes, in the field of the own block number in the state information table TBL2, a number obtained by incrementing the maximum block number included in the path information string PIS by 1 (S14).

As explained above, the empty path information string PIS is attached to the search request command SC transmitted in SI in FIG. 10.

Therefore, the CPU 41 of the block 2(1) writes “1” in the field of the own block number in the state information table TBL2 and writes “START” in the field of the search state of the transmitting and receiving section 40A corresponding to the input transmitting and receiving section.

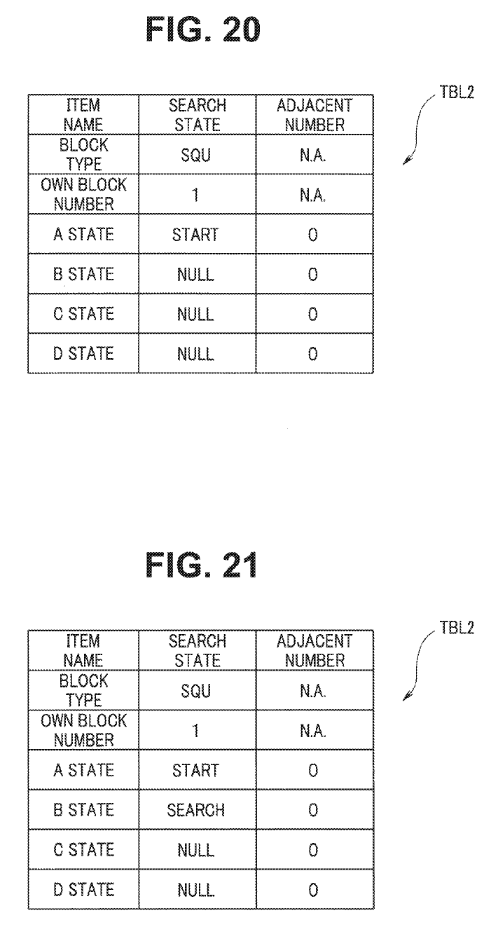

FIG. 20 is a diagram showing a state of the state information table TBL2 after the block 2(1) receives the search request command SC from the smartphone 7 in the transmitting and receiving section 40A and executes the processing in S14.

Note that in the case of the block 2(1), the search request command SC is received from the smartphone 7. Therefore, the adjacent number of the transmitting and receiving section 40A, which is the input transmitting and receiving section, is “0” as shown in FIG. 20. However, when the search request command SC is received from another block 2, the CPUs 41 of the respective blocks 2 extract the block number of the block 2, which transmits the search request command SC, from path information PI at an end of the path information string PIS and write the block number in the field of the adjacent numbers of the input transmitting and receiving sections.

Subsequently, the CPUs 41 search for a transmitting and receiving section, the search state of which is NULL, in predetermined order. If the transmitting and receiving section, the search state of which is NULL, is present, the CPUs 41 set the transmitting and receiving section as an output transmitting and receiving section and set the search state of the output transmitting and receiving section to SEARCH (S15). Note that when only one transmitting and receiving section exists, the transmitting and receiving section, the search state of which is “NULL”, is absent.

The predetermined order is determined in advance in the respective blocks. The predetermined order is determined here as cyclical order in such a manner as the transmitting and receiving sections 40A, 40B, 40C, 40D, 40A, 40B, . . .

The search states of the transmitting and receiving sections 40B, 40C, and 40D other than the transmitting and receiving section 40A are “NULL”. Therefore, first, the CPU 41 of the block 2(1) sets the transmitting and receiving section 40B as the output transmitting and receiving section and sets the search state of the transmitting and receiving section 40B to “SEARCH” according to the predetermined order.

FIG. 21 is a diagram showing a state of the state information table TBL2 at the time when the transmitting and receiving section 40B is set as the output transmitting and receiving section first according to the execution of the processing in S15 in the block 2(1).

After S15, the CPU 41 of the block 2(1) determines whether the transmitting and receiving section, the search state of Which is “NULL”, is present in S15 (S16). S16 is processing for determining whether all the transmitting and receiving sections are checked.

When the transmitting and receiving section, the search state of which is “NULL”, is present (YES in S16), the CPU 41 of the block 2(1) adds the path information PI to the end of the path information string PIS and generates a new path information string PIS (S17).

The path information PI is explained. The path information PI includes (input transmitting and receiving section identifier.shape identifier (own block number).output transmitting and receiving section identifier).

After S17, the CPU 41 of the block 2(1) transmits the search request command SC attached with the path information string PIS from the output transmitting and receiving section (S18).

For example, in the case explained above, the search state of the transmitting and receiving section 40B of the block 2(1) is “NULL”. Therefore, the CPU 41 of the block 2(1) transmits the search request command SC attached with the path information string PIS from the transmitting and receiving section 40B, which is the output transmitting and receiving section. The path information string PIS at this time is as described below.

(A.Squ(1).B) . . . string 1

As explained above, the path information PI is now empty in the search request command SC from the smartphone 7. Therefore, the path information string PIS included in the search request command SC transmitted from the transmitting and receiving section 40B in S18 is the string 1 explained above.

After S18, the CPU 41 of the block 2(1) sets a timer concerning a search request, which is a software timer or the like, (S19). The processing returns to S12.

The transmitting and receiving section 40B of the block 2(1) shown in FIG. 9 functions as the output transmitting and receiving section. The CPU 41 of the block 2(1) outputs the search request command SC generated in S17 to the block 2(2).

The CPU 41 of the block 2(1) returns to the processing in S12. However, because the CPU 41 receives a communication response signal from the block 2(2), the set timer is released. As a result, the timeout signal is not output from the timer.

In the case of FIG. 9, the block 2(2) receives, in the transmitting and receiving section 40C, the search request command SC transmitted from the transmitting and receiving section 40B of the block 2(1). The CPU 41 of the block 2(2) starts the execution of the processing shown in FIG. 14 in response to the reception of the received search request command SC.

The CPU 41 of the block 2(2) executes the processing in S11 to S19 explained above. As a result, the state information table TBL2 is generated in the RAM 43 of the block 2(2). In S14, because the maximum block number in the path information string PIS included in the search request command SC is “1”, the CPU 41 of the block 2(2) sets the own block number to “2” and sets a state C concerning the transmitting and receiving section 40C, which is the input transmitting and receiving section, to “IN”.

Further, in S15, the CPU 41 of the block 2(2) sets the transmitting and receiving section 40D as the output transmitting and receiving section, sets the search state of a state D corresponding to the transmitting and receiving section 40D to “SEARCH” (S15) and executes S16 to S19.

As shown in FIG. 9, a coupled block is absent on the side D of the transmitting and receiving section 40D of the block 2(2). Therefore, in S12, the CPU 41 of the block 2(2) detects, that is, receives the timeout signal of the timer set in S19. As shown in FIG. 16, the CPU 41 changes the search state of the transmitting and receiving section 40D, which is the output transmitting and receiving section, from “SEARCH” to “EDGE” and sets the adjacent number to “0” (zero) (S21).

That is, the control section 32 determines presence or absence of the other blocks 2 on the respective surfaces on the basis of whether a predetermined signal (a communication response signal) is received within the predetermined time period set in the timer according to the transmission of the search request command SC.

The CPU 41 of the block 2(2) replaces the end of the path information string PIS with (input transmitting and receiving section identifier.shape identifier (own block number).output transmitting and receiving section identifier.“Edge”) and generates a new path information string PIS (S22). The new path information string PIS is as described below.

(A.Squ(1).B)(C.Squ(2).D.Edge) . . . string 2

The CPU 41 of the block 2(2) sets the output transmitting and receiving section as the input transmitting and receiving section (S23). In the case explained above, the transmitting and receiving section 40D of the block 2(2) is set as the input transmitting and receiving section.

Thereafter, the processing shifts to S15. The CPU 41 of the block 2(2) set the transmitting and receiving section 40A as the output transmitting and receiving section according to the predetermined order, sets the search state of the state A corresponding to the transmitting and receiving section 40A to “SEARCH”, and executes S16 to S19.

As shown in FIG. 9, as in the transmitting and receiving section 40D, a coupled block is absent on the side A of the transmitting and receiving section 40A of the block 2(2). Therefore, the CPU 41 of the block 2(2) executes the processing in S21 to S23.

The CPU 41 of the block 2(2) sets the transmitting and receiving section 40B as the output transmitting and receiving section according to the predetermined order, sets the search state of the state B corresponding to the transmitting and receiving section 40B to “SEARCH” (S15), and executes S16 to S19. The block 2(3) is present on the side B of the transmitting and receiving section 40B of the block 2(2). Therefore, because the transmitting and receiving section 40B receives the communication response signal from the transmitting and receiving section 40A of the block 2(3), the timer is released.

At this time, the path information string PIS included in the search request command SC transmitted from the block 2(2) to the block 2(3) is as described below.

(A.Squ(1).B)(C.Squ(2).D.Edge)(D.Squ(2).A.Edge)(A.Squ(2).B) . . . string 3

That is, the path information string PIS included in the search request command SC increases, in which the path information PI is added to the received path information string PIS.

Thereafter, similarly, in the case of the display system 1 shown in FIG. 9, the respective blocks 2 execute the similar processing, whereby the search request command SC attached with the path information string PIS is transmitted from the block 2(2) to the block 2(3), the block 2(4), the block 2(5), the block 2(6), the block 2(7), and the block 2(8) in the order.

The CPU 41 of the block 2(8) receives the search request command SC in the transmitting and receiving section 40A. Thereafter, because a coupled block is absent on the side B and the side C, the CPU 41 of the block 2(8) transmits the search request command SC from the transmitting and receiving section 40A to the block 2(1).

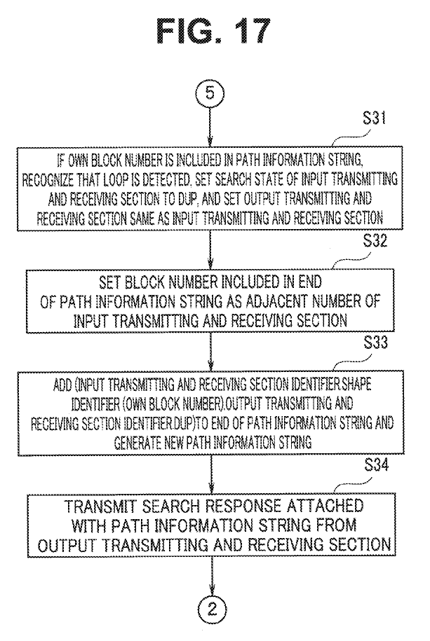

When receiving the search request command SC from the block 2(8), because the own block number is not “0” (NO in S13), as shown in FIG. 17, if the own block number is included in the path information string PIS, the CPU 41 of the block 2(1) recognizes that a loop is detected, sets the search state of the transmitting and receiving section 40D, which is the input transmitting and receiving section, to “DUP” (an abbreviation of duplication), and sets the output transmitting and receiving section the same as the input transmitting and receiving section (S31). The loop means that the transmitted search request command SC returns to the own block 2. The output transmitting and receiving section is set the same as the input transmitting and receiving section in order to return the received search request command SC to the block 2, which transmits the search request command SC, as a search response.

The CPU 41 of the block 2(1) sets a block number included in the end of the path information string PIS as an adjacent number of the input transmitting and receiving section (S32).

Further, the CPU 41 of the block 2(1) adds (input transmitting and receiving section identifier.shape identifier (own block number).output transmitting and receiving section identifier.DUP) to the end of the path information string PIS and generates new path information string PIS (S33).

The CPU 41 of the block 2(1) transmits the search request command SC attached with the path information string PIS from the output transmitting and receiving section as the search response RC (S34).

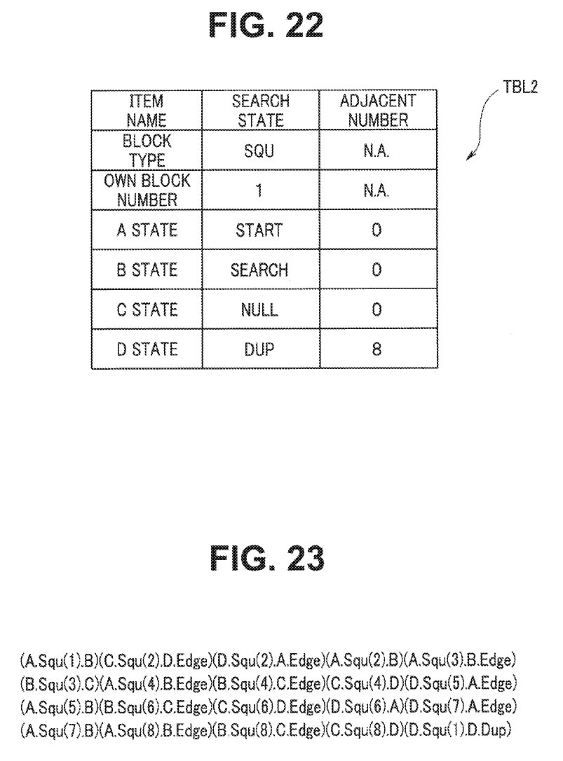

FIG. 22 is a diagram showing a state of the state information table TBL2 in the block 2(1) that transmits the search response RC to the block 2(8). As shown in FIG. 22, the search state of the side D of the state information table TBL2 in the block 2(1) at this time is “DUP”. The adjacent number of the side D is “8”.

FIG. 23 is a diagram showing the path information string PIS included in the search response RC transmitted to the block 2(8) by the block 2(1). The search response RC transmitted from the block 2(1) to the block 2(8) is a command having the same configuration as the search request command SC including the path information string PIS shown in FIG. 23. As shown in FIG. 23, in the search request command SC transmitted from the start block 2S, that is, the block 2(1), the path information PI is added and increase during search and transfer.

After S34, the processing of the CPU 41 of the block 2(1) shifts to S12.

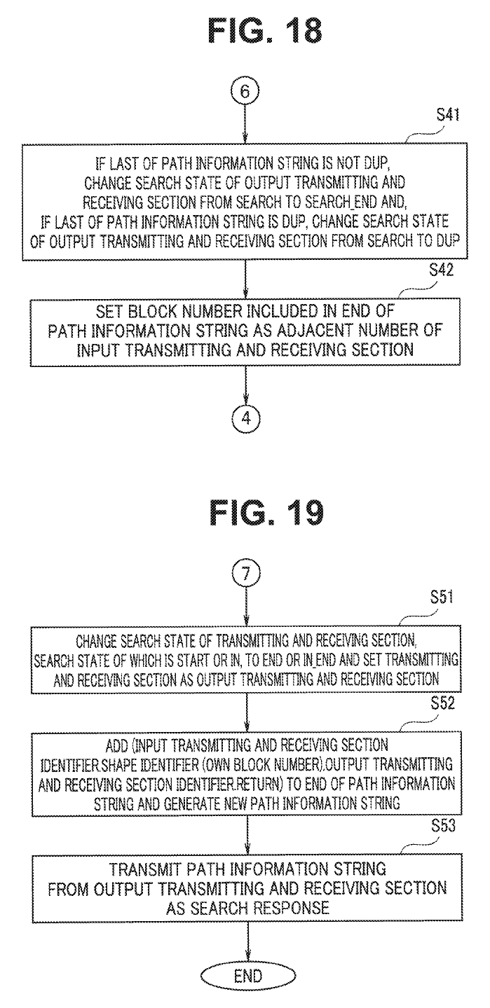

When receiving the search response RC from the block 2(1), the CPU 41 of the block 2(8) shifts from 512 in FIG. 14 to processing shown in FIG. 18. If a last of the path information string PIS included in the received search response RC is not “DUP”, the CPU 41 changes the search state of the output transmitting and receiving section from “SEARCH” to “SEARCH_END”. If the last of the path information string PIS is “DUP”, the CPU 41 changes the search state of the output transmitting and receiving section from “SEARCH” to “DUP” (S41).

The CPU 41 of the block 2(8) sets the block number included in the end of the path information string PIS as the adjacent number of the input transmitting and receiving section (S42). The processing shifts to S15. Therefore, although not shown in FIG. 23, the search state of the side D of the state information table TBL2 of the block 2(8) changes to “DUP” and the adjacent number of the side D changes to “1”.

Thereafter, the CPU 41 of the block 2(8) executes the processing in S15 in FIG. 14 and determines whether the transmitting and receiving section, the search state of which is “NULL”, is present (S16). In the case of FIG. 9, the transmitting and receiving section, the search state of which is “NULL”, is absent (NO in S16). Therefore, the CPU 41 of the block 2(8) executes processing in FIG. 19, changes the search stage of the transmitting and receiving section, the search state of which is “START” or “IN”, to “END” or “IN_END” and sets the transmitting and receiving section as the output transmitting and receiving section (S51).

Further, the CPU 41 of the block 2(8) adds (input transmitting and receiving section identifier.shape identifier (own block number).output transmitting and receiving section identifier.RETURN) to the end of the path information string PIS and generates new path information string PIS (S52).

The CPU 41 of the block 2(8) transmits the search request command SC including the path information string PIS from the output transmitting and receiving section as the search response RC (S53) and ends the processing.

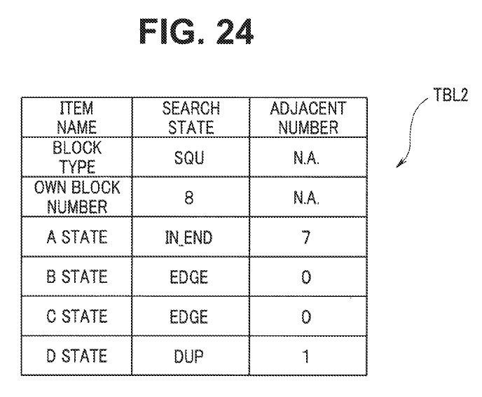

FIG. 24 is a diagram showing a state of the state information table TBL2 of the block 2(8) at the time when the block 2(8) transmits the search response RC to the block 2(7). As shown in FIG. 24, in the state information table TBL2 in the block 2(8), the search states of the sides A, B, C, and D are respectively “IN_END”, “EDGE”, “EDGE”, and “DUP” and the adjacent numbers of the sides A, B, C, and D are respectively “7”, “0”, “0”, and “1”.

Therefore, the CPU 41 of the block 2(8) transmits the search request command SC to the block 2(7) from the transmitting and receiving section 40A according to an end of the search of the transmitting and receiving section 40D (S53).

The block 2(7), which receives the search request command SC from the block 2(8), transmits the search request command SC from the transmitting and receiving section 40C, the search state of which is “NULL”, to the block 2(9) (S18) and sets the timer (S19).

The CPU 41 of the block 2(9), which receives the search request command SC from the block 2(7), transmits the search request command SC from the transmitting and receiving section 401) according to the predetermined order (S18). The coupled block 2(1) is present on the side D of the transmitting and receiving section 40D of the block 2(9). Therefore, “DUP” is included in the end of the path information string PIS transmitted from the block 2(1) (S33). Therefore, the CPU 41 of the block 2(9) sets the search state of the side D corresponding to the transmitting and receiving section 40D to “DUP” (S31) and sets the adjacent number of the transmitting and receiving section 40D to “1” (S32).

Thereafter, similarly, the CPU 41 of the block 2(9) transmits the search request command SC from the transmitting and receiving section 40A according to the predetermined order. Because “DUP” is included in the end of the path information string PIS transmitted from the block 2(3), the CPU 41 sets the search state of the transmitting and receiving section 40A of the block 2(9) to “DUP” (S31) and sets the adjacent number of the side A of the transmitting and receiving section 40A to “3” (S32).

Similarly, the CPU 41 of the block 2(9) transmits the search request command SC from the transmitting and receiving section 40B according to the predetermined order. Because “DUP” is included in the end of the path information string PIS transmitted from the block 2(5), the CPU 41 sets the search state of the transmitting and receiving section 40B of the block 2(9) to “DUP” (S31) and sets the adjacent number of the transmitting and receiving section 40A to “5” (S32).

Thereafter; the transmitting and receiving section, the search state of which is “NULL”, is absent (NO in S16). Therefore, the CPU 41 of the block 2(9) executes the processing in FIG. 18 and transmits the search response RC including the path information string PIS from the transmitting and receiving section 40C to the block 2(7) (S53).

The CPU 41 of the block 2(7) also transmits the search response RC including the path information string PIS from the transmitting and receiving section 40D of the block 2(7) to the block 2(6) according to the reception of the search response RC from the block 2(9) (S53). Thereafter, similarly, the search response RC is transmitted from the block 2(6) to return to the block 2(1).

Note that in the case of the display system 1 shown in FIG. 9, the transmitting and receiving section 40C of the block 2(5) and the transmitting and receiving section 40D of the block 2(3) receive the search response RC including “DUP” in the end from the block 2(9) to which the search request command SC is transmitted. Therefore, the CPUs 41 of the respective blocks 2(5) and 2(3) can determine a number of the block 2(9), to which the blocks 2(5) and 2(3) are adjacent, that is, the adjacent number “9”.

Finally, when receiving the search response RC in the transmitting and receiving section 40B of the block 2(1), the CPU 41 of the block 2(1) changes the search state of the transmitting and receiving section 40B to “SEARCH_END” (S41).

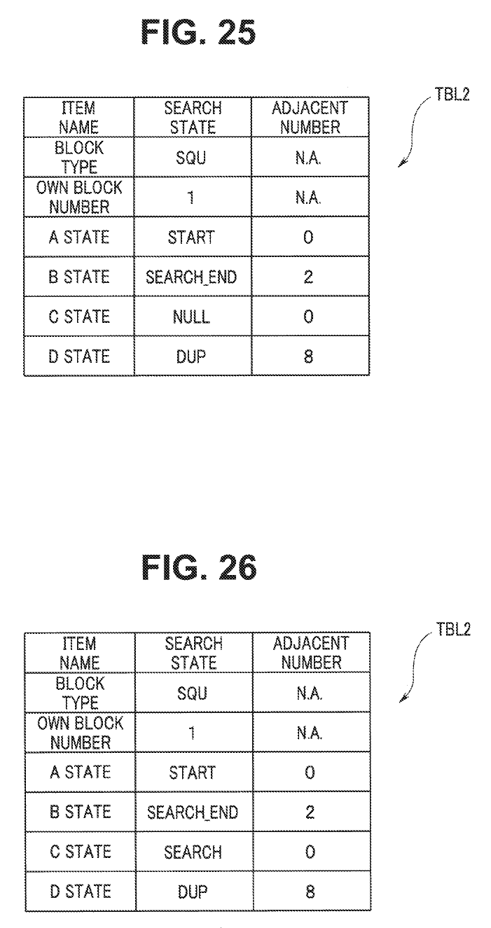

FIG. 25 is a diagram showing a state of the state information table TBL2 after the block 2(1) receives the search response RC from the block 2(2).

Subsequently, the CPU 41 of the block 2(1) transmits the search request command SC from the transmitting and receiving section 40C according to the predetermined order.

FIG. 26 is a diagram showing a state of the state information table TBL2 at the time when the block 2(1) transmits the search request command SC to the block 2(9).

Subsequently, the CPU 41 of the block 2(1) receives the search response RC including “DUP” in the end from the block 2(9) to which the search request command SC is transmitted. Therefore, the CPU 41 of the block 2(1) can set the search state of the side C to “DUP” and determine a number of the block 2(9) adjacent to the block 2(1), that is, the adjacent number “9”.

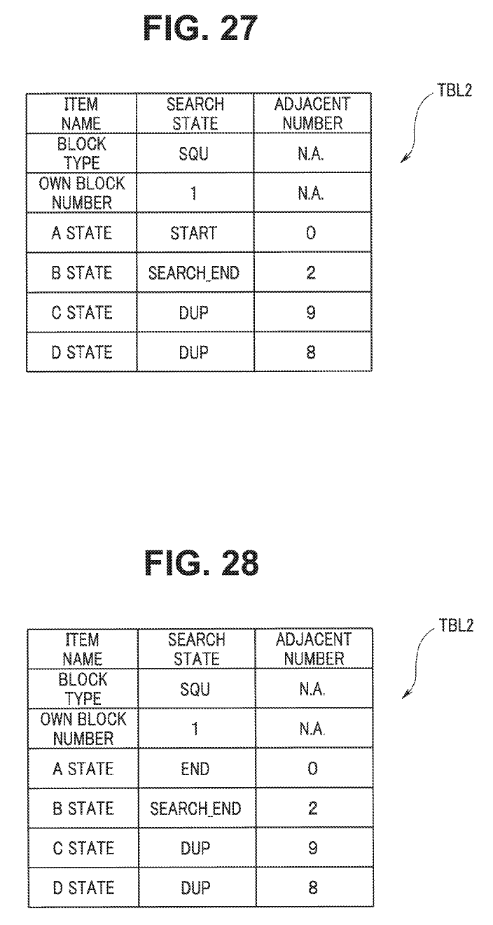

FIG. 27 is a diagram showing a state of the state information table TBL2 after the block 2(1) receives the search response RC from the block 2(9).

Subsequently, the CPU 41 of the block 2(1) transmits the search request command SC from the transmitting and receiving section 401D according to the predetermined order. The CPU 41 receives the search response RC including “DUP” in the end from the block 2(8) to which the search request command SC is transmitted.

Finally, the CPU 41 of the block 2(1) changes the search state of the transmitting and receiving section 40A, the search state of which is “START”, to “END” (S51) and transmits the search response RC including the path information string PIS from the transmitting and receiving section 40A to the smartphone 7 (S53).

FIG. 28 is a diagram showing a state of the state information table TBL2 after the block 2(1) receives the search response RC from the block 2(8).

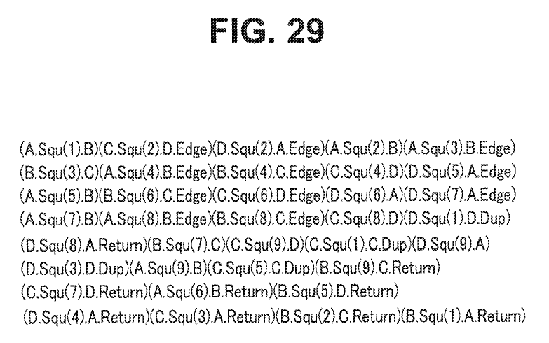

FIG. 29 is a diagram showing the path information string PIS included in the search response RC transmitted from the block 2(1) to the smartphone 7.

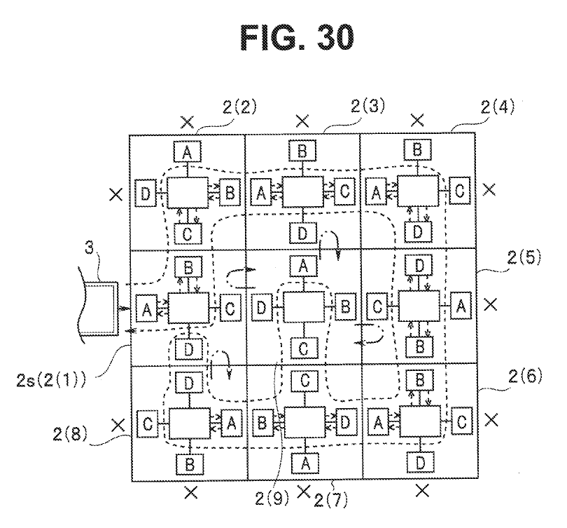

FIG. 30 is a diagram showing a flow of the search request command SC in the display system 1. As indicated by a dotted line in FIG. 30, the block 2(1) that receives the search request command SC functions as the start block 2S. The search request command SC is transmitted from the block 2(1) to the other blocks 2. The search request command SC returns to the block 2(1) like a single stroke of the brush.

In FIG. 30, cross marks (X) indicate sides on which adjacent blocks are absent. In FIG. 30, U-turn marks indicated by alternate long and two short dashes lines indicate places where loops are detected. The search request command SC includes the path information string PIS. The path information string PIS includes block numbers generated and given in the respective blocks 2, end portion information (“EDGE” described above) of sides on Which adjacent blocks are absent in the respective blocks 2, and loop information (“DUP” described above) indicating presence of an already searched block.

As explained above, the control sections 32 of the respective blocks 2 configure information-transmission control sections that, when receiving the search request command SC including the path information string PIS, determine presence or absence of other blocks disposed adjacent to the respective surfaces on which the transmitting and receiving sections 40, which are the communication sections, are provided, add, on the basis of a determination result of the presence or absence of the other blocks, information including block numbers, which is identification information of the other blocks disposed adjacent to the respective surfaces, to the path information string PIS included in the search request command SC to generate the search request command SC or the search response RC, and transmit the search request command SC or the search response RC from any one of the plurality of transmitting and receiving sections 40. The search request command SC or the search response RC is information obtained by including or adding, in or to the received search request command SC or the received search response RC, information concerning the presence or absence of the other blocks on the respective surfaces and identification information of the other blocks.

In particular, the control section 32, which is an information-transmission control section, includes, on the basis of a result of the determination of the presence or absence of the other blocks, in the path information string PIS, information (“EDGE” described above) indicating that the other blocks are absent concerning the surfaces on which the other blocks disposed adjacent to one another are absent.

Further, when the received search request command SC includes the search request command SC transmitted by the control section 32, the control section 32, which is the information-transmission control section, includes information indicating a loop (“DUP” described above) in the path information string PIS.

### (Adjacency Matrix Creation Processing in The Smartphone)

As explained above, the smartphone 7 receives the search response RC from the start block 2S in S2 in FIG. 10. As explained above, the CPU 53 of the smartphone 7 executes the adjacency matrix creation processing on the basis of the path information string PIS included in the received search response command RC and the display block information table TBL1 explained above and generates block disposition information of the display system 1 (S3).

FIG. 31 is a flowchart showing an example of a flow of the adjacency matrix creation processing for generating the block disposition information in S3.

The CPU 53 executes adjacency matrix initialization processing (S101). FIG. 32 is a flowchart showing an example of a flow of the adjacent matrix initialization processing.

The CPU 53 reads the path information string PIS from a head and, every time a new block number is found, determines the number of surfaces (or sides) of the block from a shape identifier of the block, and calculates a sum of numbers of surfaces of all the blocks (S111).

The CPU 53 creates an empty square adjacency matrix having a size of the sum of the numbers of the surfaces and allocates, for each block, rows and columns by the number of surfaces of the block (S112).

In the case of the display system 1 shown in FIG. 9, the number of surfaces is nine and the respective blocks 2 are squares having four sides. Therefore, a 36×36 matrix table is generated.

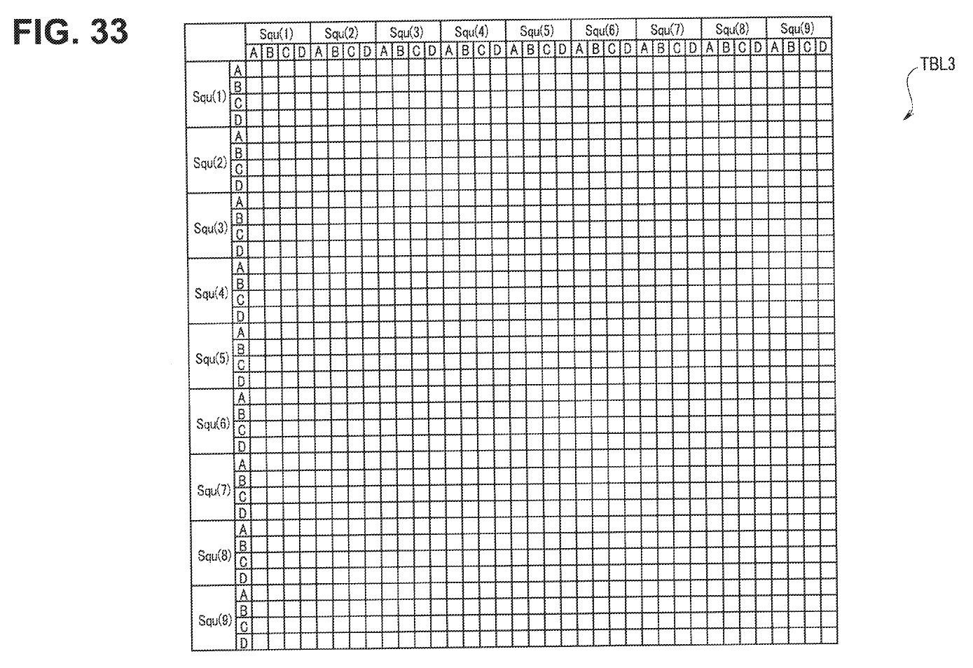

FIG. 33 is a diagram showing an example of the adjacency matrix table venerated in S112.

Referring back to FIG. 31, the CPU 53 returns a readout target to the head of the path information string PIS (S102). That is, a position of the path information PI of the readout target becomes a position of path information of a head position of the path information string PIS.

The CPU 53 reads adjacent partial strings (a partial string pair) of the path information string PIS (S103). Each partial string is one kind of path information PI. Therefore, the partial string pair is adjacent two kinds of path information PI.

In the following explanation, the partial string pair is indicated by (X1.FormX(#X).X2.<any>)(Y1.FormY(#Y).Y2.<any>). Each of (X1.FormX(#X).X2.<any>) and (Y1.FormY(#Y).Y2.<any>) is the path information PI. X1 and Y1 are input transmitting and receiving section identifiers. FormX(#X) and FormY(#Y) are shape identifiers (own block numbers), and X2 and Y2 are output transmitting and receiving section identifiers. <any> is any one of empty (in this case, meaning a search request), Dup, Edge, and Return.

If the read partial string pair is (X1.FormX(#X).X2)(Y1.FormY(#Y).Y2.<any>), a surface X2 of a block is adjacent to a surface Y1 of a block #Y. Therefore, the CPU 53 sets corresponding elements of the adjacency matrix to 1 and sets elements other than the elements of rows or columns including the elements to zero (S104).

Subsequently, if the partial string pair is (X1.FormX(#X).X2.EDGE)(Y1.FormY(#Y).Y2.<any>), the surface X2 of the block #X is adjacent to no block. Therefore, the CPU 53 sets all elements of corresponding rows and columns of the adjacency matrix to zero (S105).

Further, when the partial string pair is a pattern other than the above, the CPU 53 does not change the adjacency matrix (S106).

The CPU 53 shifts the readout target backward by one partial string (S107). That is, a range of the readout target is moved such that the path information PI in a back of the partial string pair becomes the path information PI in a front in a partial string pair read out next.

The CPU 53 determines whether the path information PI in the back of the partial string pair is an end of the path information string PIS (S108). That is, the CPU 53 determines whether the read-out target partial string pair includes the path information PI of the end of the path information string PIS.

If the path information P1 in the back of the partial string pair is not the path information PI of the end of the path information string PIS (YES in S108), the processing returns to S103. If the path information PI in the back of the partial string pair is the path information PI of the end of the path information string PIS (NO in S108), the processing ends.

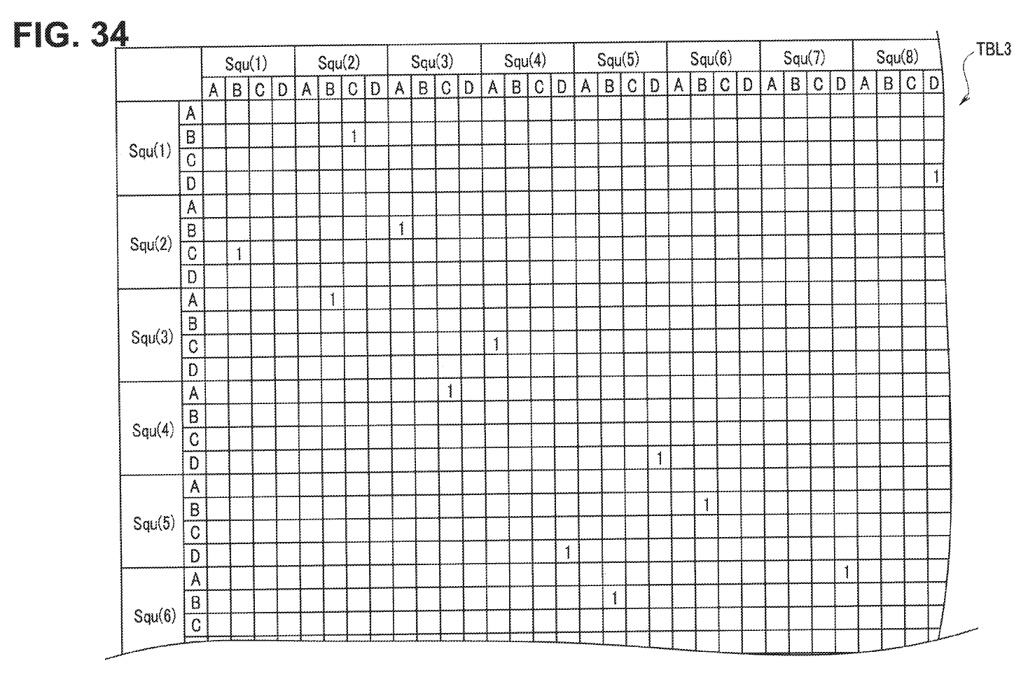

According to the processing explained above, an adjacent matrix table TBL3 shown in FIG. 34 is created.

FIG. 34 is a diagram showing a part of the adjacent matrix table TBL3 including information concerning a connection relation among the blocks 2 as a result of the processing shown in FIG. 30. In FIG. 34, “0” is omitted and is not shown. The adjacency matrix generated as explained above includes all kinds of connection information among the blocks 2. Therefore, the CPU 53 of the smartphone 7 can generate block disposition information on the basis of the generated adjacency matrix table TBL3.

As a result, the CPU 53 can divide the image selected in S4 on the basis of the block disposition information and generate display image information including a plurality of kinds of block image information.

### (Wireless Power Feeding Method Among the Respective Blocks Using Coils for Wireless Power Feeding)

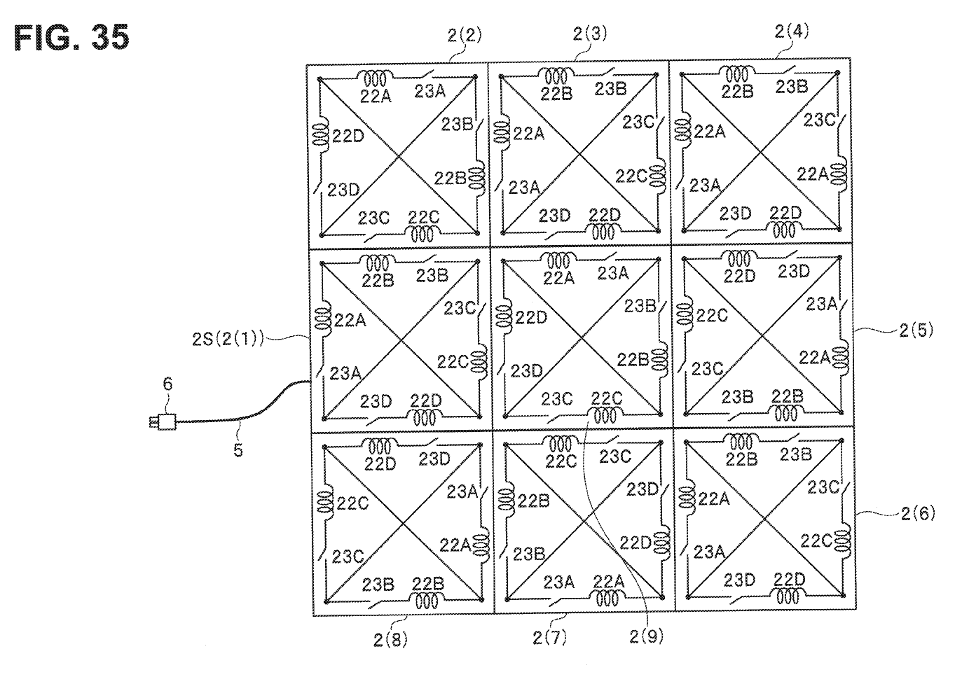

In FIG. 35, for explanation of wireless power feeding using the coil section for wireless power feeding 20 shown in FIG. 4, coils for wireless power feeding 22A to 22D and switches 23A to 23D connected in series to the respective coils for wireless power feeding 22A to 22D are shown in the respective blocks 2.

To distinguish the respective blocks 2, the blocks 2 are represented as, starting from 2S (2(1)), which is the start block, 2(2) to 2(9).

A voltage from a 100 V AC power supply is connected to, via the outlet 6 and the power supply wire 5, the socket 13 (not shown in FIG. 35) provided in one side surface section 3 of the start block 2S. Consequently, as shown in FIG. 4, an AC voltage applied to the socket 13 is applied between the wire end portions a and b of the coil section for wireless power feeding 20 shown in FIG. 3.

It is assumed that, prior to the wireless power feeding, because the disposition search explained above is performed using the transmitting and receiving sections 40A to 40D including the respective NFC coil 11 of the respective blocks 2 explained referring to FIGS. 8 to 34, the respective blocks 2 configuring the display system 1 recognize to which other blocks 2 the respective blocks 2 are coupled and the smartphone 7 also recognizes a disposition relation among all the blocks 2.

The respective coils for wireless power feeding 22A to 22D are disposed according to disposition of the respective transmitting and receiving sections 40A to 40D of the respective blocks 9 shown in FIG. 9. It is assumed that the control sections 32 of the respective blocks 2 recognize the correspondence relation in advance.

It is assumed that the start block 2S or the smartphone 7 recognizes the path information string PIS obtained in the disposition search explained above as being directly replaced as the path information string PIS concerning disposition of the respective coils for wireless power feeding 22A to 22D of the respective blocks 2.

The smartphone 7 may grasp, in advance, respective kinds of peculiar identification information (MAC addresses, manufacturing numbers, and the like) and attribute information (various kinds of information and the like shown in FIG. 8) of the respective blocks 2 used in the display system 1 or may acquire, according to the disposition search, peculiar information and attribute information stored by the respective blocks 2S to 2(9).

The wireless power feeding method among the respective blocks 2 is explained below referring to FIG. 35.

Step 1-1:

The smartphone 7 instructs the start block 2S (the block 2(1)) to start wireless power feeding to the respective blocks 2. Note that the start block 2S itself may start the wireless power feeding without being instructed by the smartphone 7 according to the end of the disposition search.

It is found out on the basis of a result of the prior disposition search that the coil for wireless power feeding 10 of the adjacent block 2 disposed to be opposed to the coil 22A of the start block 2S is absent. Therefore, the control section 32 causes the switching section 33 to turn on the switch 23B paired with the coil for wireless power feeding 22B in the next order.

The control section 32 instructs, from the transmitting and receiving section 40B of the control section 32, via the transmitting and receiving section 40C of the block 2(2) adjacent to the transmitting and receiving section 40B, the control section 32 of the block 2(2) to turn on the switch 23C. The control section 32 of the block 2(2) turns on the switch 23C with the switching section 33 on the basis of the instruction.

Consequently, an induced electromotive force is generated in the coil for wireless power feeding 22C of the block 2(2) by an AC voltage applied to the coil for wireless power feeding 22B of the start block 2S, whereby electric power by wireless power feeding is supplied to the internal circuit 21 of the block 2(2).

Consequently, electric power of the system operation is switched from the battery 35 to the wireless power feeding. Therefore, no risk of a dead battery exists due to operation of the system with only the electric power of the battery 35.

Step 1-2:

The control section 32 of the block 2(2) transfers response data of the supply of the electric power by the wireless power feeding from the transmitting and receiving section 40C to the control section 32 via the transmitting and receiving section 40B of the start block 2S.

When the control section 32 of the start block 2S receives the response data, the control section 32 turns on the switch 23C as the next order.

In the same manner as the step explained above, the control section 32 instructs the control section 32 of the block 2(9) to turn on the switch 23D. In response to the instruction, the control section 32 of the block 2(9) turns on the switch 23D.

An induced electromotive force is generated in the coil for wireless power feeding 22D of the block 2(9) by the AC voltage applied to the coil for wireless power feeding 22C of the start block 2S. Therefore, the electric power by the wireless power feeding is supplied to the internal circuit 21 of the block 2(9), whereby the electric power of the system operation is switched from the battery 35 to the wireless power feeding.

Step 1-3:

After confirming response data indicating that the electric power by the wireless power feeding is supplied from the block 2(9), the start block 2S turns on the switch 230 as the next order.

In the same manner as explained above, the control section 32 transfers data for instructing the control section 32 to turn on the switch 23D of the block 2(8) to the control section 32. In response to the instruction, the control section 32 turns on the switch 230.

An induced electromotive force is generated in the coil for wireless power feeding 22D of the block 2(8) by the AC voltage applied to the coil for wireless power feeding 220 of the start block 2S. Therefore, the electric power by the wireless power feeding is supplied to the internal circuit 21 of the block 2(8), whereby the electric power of the system operation is switched from the battery 35 to the wireless power feeding.

Step 2-1:

After confirming response data indicating that the electric power is supplied by the wireless power feeding from the block 2(8), the start block 2S instructs the block 2(2), to which the wireless power feeding is performed first, to perform the wireless power feeding to the block 2(3) in a second stage of the wireless power feeding.

In response to the instruction, the control section 32 of the block 2(2) turns on the switch 23B. The control section 32 instructs the control section 32 of the block 2(3) to turn on the switch 23A. In response to the instruction, the control section 32 of the block 2(3) turns on the switch 23A.

An induced electromotive force is generated in the coil for wireless power feeding 22C of the block 2(3) by the AC voltage applied to the coil for wireless power feeding 22B of the block 2(2). Therefore, the electric power by the wireless power feeding is supplied to the internal circuit 21 of the block 2(3), whereby the electric power of the system operation is switched from the battery 35 to the wireless power feeding.

Step 2-2:

After confirming, via the block 2(2), response data indicating that the electric power is supplied to the block 2(3) by the wireless power feeding, the start block 2S instructs the block 2(9), to which the wireless power feeding is performed second, to supply electric power by the wireless power feeding to the block 2(5) in the second stage of the wireless power feeding. The instruction is based on the fact that the wireless power feeding to the block 2(3) has already been performed.

The control section 32 of the block 2(9) turns on the switch 23B and instructs the block 2(5) to turn on the switch 23C. In response to the instruction, the control section 32 of the block 2(5) turns on the switch 23C.

An induced electromotive force is generated in the coil for wireless power feeding 22C of the block 2(5) by the AC voltage applied to the coil for wireless power feeding 22B of the block 2(9). Therefore, the electric power by the wireless power feeding is supplied to the internal circuit 21 of the block 2(5), whereby the electric power of the system operation is switched from the battery 35 to the wireless power feeding.

Step 2-3:

After confirming, via the block 2(9), response data indicating that the electric power is supplied by the wireless power feeding to the block 2(5), the start block 2S instructs the block 2(8), to which the wireless power feeding is performed third, to supply electric power by the wireless power feeding to the block 2(7) in the second stage of the wireless power feeding. The instruction is based on the fact that the wireless power feeding to the block 2(9) has already been performed.

The control section 32 of the block 2(8) turns on the switch 23A and instructs the block 2(7) to turn on the switch 23B. In response to the instruction, the control section 32 of the block 2(7) turns on the switch 23B.

An induced electromotive force is generated in the coil for wireless power feeding 22B of the block 2(7) by the AC voltage applied to the coil for wireless power feeding 22A of the block 2(8). Therefore, the electric power by the wireless power feeding is supplied to the internal circuit 21 of the block 2(7), whereby the electric power of the system operation is switched from the battery 35 to the wireless power feeding.

A step of the wireless power feeding to the block 2(4) in the third stage and a step of the wireless power feeding to the block 2(6) in the third stage are evident from the respective steps explained above. Therefore, explanation of the steps is omitted.

The start block 2S ends an instruction for new wireless power feeding at a stage when the start block 2S receives all confirmation data indicating that the wireless power feeding from the other respective blocks 2 excluding the start block 2S configuring the display system 1 is started. Consequently, electric power is supplied to all the blocks 2 excluding the start block 2S by the wireless power feeding based on the AC voltage connected to the start block 2S.

In the wireless power feeding explained above, a power loss due to a leak of a magnetic flux in electromagnetic induction occurs in the wireless power feeding from the block 2 to the block 2 adjacent to the block 2. Therefore, as the number of the blocks 2 of the wireless power feeding increases, the power loss occurs more in the wireless power feeding of the respective blocks 2. Therefore, the wireless power feeding to the block 2 most distant from the start block 2S cannot be sufficiently performed by one AC voltage.

As a method for coping with such a situation, for example, the problem of the power loss in the wireless power feeding may be solved by connecting a second AC power supply of the display system 1 to the block 2 (in FIG. 35, for example, the block 2(4)) most distant from the start block 2S.

Note that the wireless power feeding from the block 2(4) to the block 2 set as a target of the wireless power feeding may be performed on the basis of an instruction from the start block 2S. However, the block 2(4) may perform the wireless power feeding independently from the start block 2S. However, naturally, the start block 2S and the block 2(4), which independently performs the wireless power feeding, cooperate each other not to cause a trouble of the wireless power feeding.

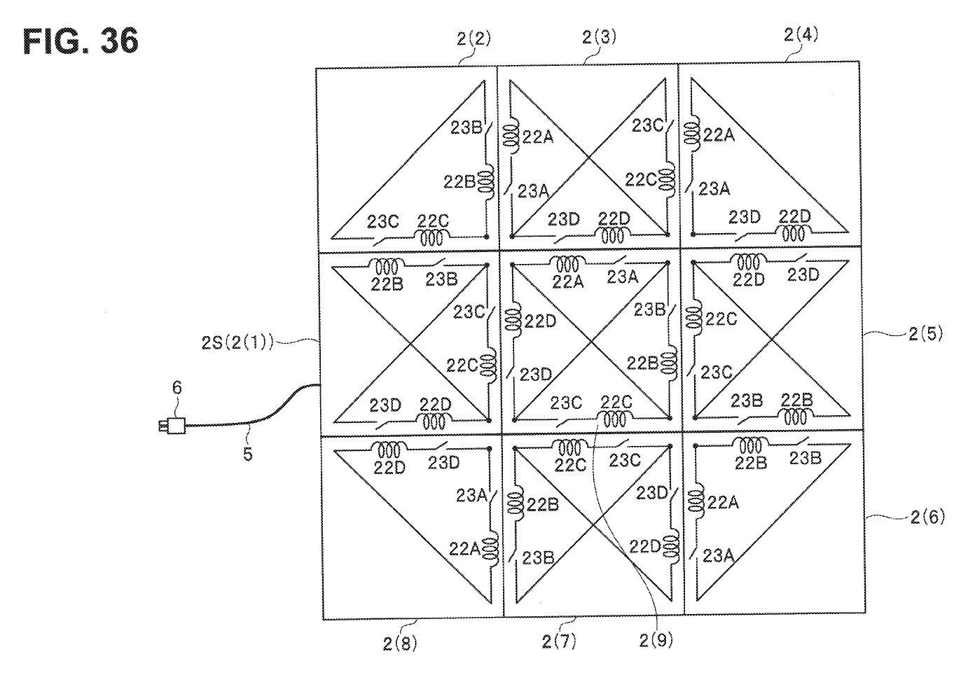

FIG. 36 is the same diagram as FIG. 35. A difference from FIG. 35 is that the blocks 2 in which parts of pair components of the transmitting and receiving sections 40 and the coils for wireless power feeding 22 and the switches 23 are curtailed are present in the display system 1.

In the respective blocks 2 configuring the display system 1, pairs of the transmitting and receiving sections 40 including the coils for wireless power feeding 10 and the coils for NFC 11 are unnecessary on the side surface section 3 sides where adjacent blocks 2 are absent disposed on an outer most side. Therefore, a configuration in which the pairs are omitted is possible. Note that it is assumed that the blocks 2 recognize the pair components in advance.

More specifically, in the start block 2S, an adjacent block 2 is absent on the side surface 3 connected to the AC power supply. Therefore, no problem exists in wireless power supply to the respective blocks 2 even if the pair component is not disposed on the side of the side surface 3.

In the block 2(2), the pair component is not disposed on the sides of two side surfaces 3. In the other respective blocks 2 as well, the pair components are absent on the side surface 3 sides where adjacent blocks 2 are absent.

In this way, if various patterns of the blocks 2 in which the pair components are deleted are created according to a disposition place of the display system 1, it is possible to reduce cost for configuring the display system 1.

Note that from exteriors of the blocks 2, it is unknown for a user the pair components of which side surface: sections 3 are deleted. Therefore, for example, specific coloring may be applied to the side surface sections 3 in which the pair components of the blocks 2 are deleted. The display system 1 of a preferred size may be configured depending on the color.

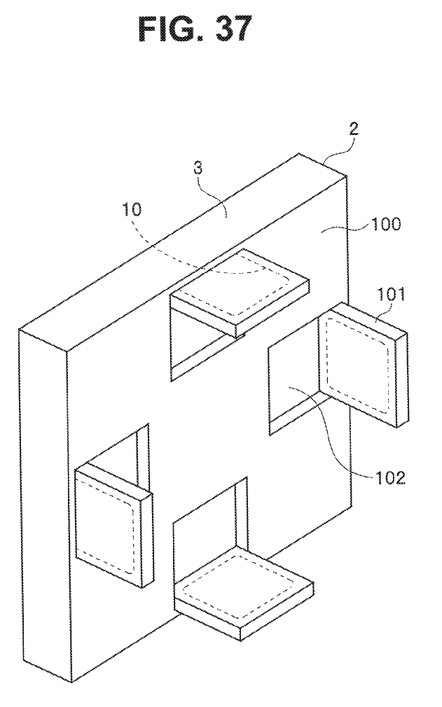

FIG. 37 is a diagram in which the respective coils for wireless power feeding 10 disposed contiguous to the respective side surface sections 3 of the blocks 2 are disposed in different places not contiguous to the respective side surface sections 3 while corresponding to the respective side surface section 3 sides.

Unlike in the past, coils for wireless power feeding are not disposed on the respective side surface section 3 sides. Four storing sections 102 are formed and disposed near the respective side surface sections 3 on a rear surface 100 on an opposite side of a surface of the block 2 on which a display panel of the display section 34 is disposed. Four housings 101 completely storable in the storing sections 102 are provided.

As one of reasons why the storable respective housings 101 are provided in the rear surface 102 is that, when it is desired to reduce thickness of the side surface section 3 of the block 2 as much as possible, it is sometimes difficult to dispose the coil for wireless power feeding 10 and the coil for NFC 11 contiguous to the side surface section 3 to correspond to the side surface section 3. En this case, only the coil for NFC 11 may be disposed contiguous to the side surface section 3. The coil for wireless power feeding 10 may be disposed in, for example, the housing 101 on the rear surface 100 from the place.

Although not shown in FIG. 37, if an intended usage exists, the coil for NFC 11 may be disposed in the housing 101 in addition to the coil for wireless power feeding 10. Note that the example of the disposition is explained in which the coils for wireless power feeding 10 and the coils for NFC 11 are not contiguous to the respective side surface section 3 sides while corresponding to the respective side surface section 3 sides. However, the disposition is not limited to this. For example, in future, if a side surface of a display such as an OLED display or a micro LED display will become extremely thin, it is sometimes undesirable to project the display section 34 of the block 2 to the rear side of the block 2 like the housing 101.

Although not shown in FIG. 37, in this case, the respective coils may be disposed on foldable, for example, flexible printed boards to be the housings 101 incorporating the coils. The housings 101 may be stored on the respective side surface section 3 sides of the blocks 2. Then, if the folded housing 101 of one block 2 of the adjacent blocks 2 is extended and the housing 101 and the folded housing 101 of the adjacent other block 2 are disposed such that the respective coils are not misaligned on the rear sides of the blocks 2, it is possible to form the display system 1 with the thickness of the respective blocks 2 further reduced.

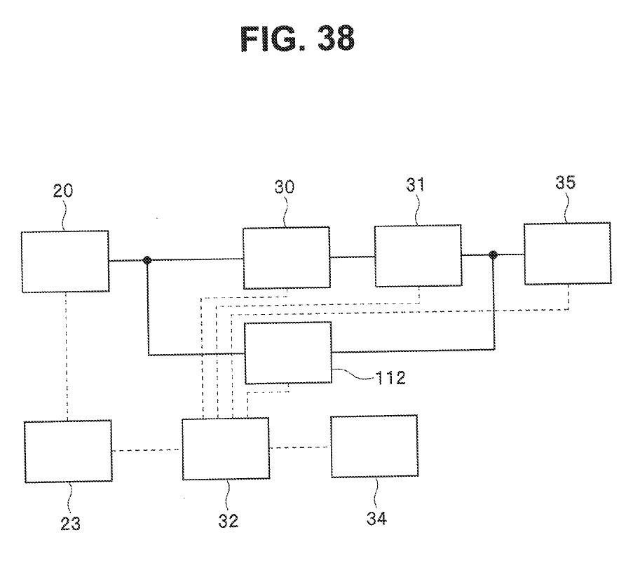

FIG. 38 is a diagram in which a DC/AC inverter 112 is added to the respective block circuits that perform the wireless power feeding shown in FIG. 5. A meaning of the addition of the DC/AC inverter 112 is explained below.

A specific example is explained below referring to data.

The wireless power feeding method explained referring to FIG. 35 is a method of forcibly performing the wireless power feeding to all the blocks 2 with one AC power supply (or a plurality of AC power supplies) to thereby operate the systems of the respective blocks 2.

In this case, a charging ratio of the batteries 35 of the respective blocks 2 remain 100% during the system operation. For example, when the batteries 35 are lithium ion batteries, the life of the batteries is shortened.

Therefore, a method of basically operating the systems with the batteries 35 and charging the batteries 35 of the blocks 2 in ascending order of priority levels according to necessity rather than forcibly performing the wireless power feeding to all the blocks 2 to operate the systems is explained below.

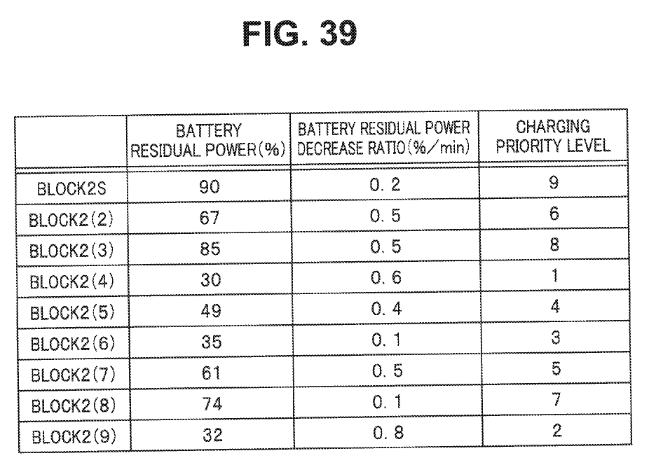

FIG. 39 is a data table showing battery states of the batteries 35 of all the blocks 2.

The start block 2S stores the data table and periodically updates data of battery states of the respective blocks 2 including the start block 2S.

For example, in wireless power feeding to the batteries 35 of at least one or more any blocks 2, setting of residual battery power of the respective batteries 35 is maintained, for example, in a range of 30% to 80%. Then, when the residual battery power deviates from the range, charging of the batteries 35 by the wireless power feeding is stopped or the charging of the batteries 35 by the wireless power feeding is started. Control for performing charging in order from the block 2 to which the wireless power feeding should be preferentially performed may be performed on the basis of the residual battery power shown in the data table rather than performing the wireless power feeding to all the blocks 2.

The start block 2S periodically refers to the data table stored by the start block 2S and selects, on the basis of the data table, the block 2 to which the wireless power feeding is preferentially necessary. Note that it is assumed that a function of grasping the residual battery power of the batteries 35 is imparted to the charger 31 and the control section 32 periodically acquires data from the charger 31.

The start block 2S determines from the battery residual power and the battery residual power decrease ratio of the data table that the block 2(4) is the block 2(4) and performs the wireless power feeding through the route of the wireless power feeding explained above.

Note that the wireless power feeding route to the block 2(4) is the start block 2S⇒the block 2(2)⇒the block 2(3)⇒the block 2(4). However, because the residual battery powers of the start block 2S, the block 2(2), and the block 2(3) are still sufficient, in the wireless power feeding, these three blocks 2 stop the wireless power feeding to the blocks 2. This is adaptable by, in FIG. 38, for example, turning off a switch (not shown in FIG. 38) provided in the AC/DC converter 30 and preventing an AC voltage by the wireless power feeding from being given to the batteries 35.

Consequently, it is possible to more quickly charge the battery 35 with the wireless power feeding to the block 2(4).

Usually, the charging may be performed until the residual battery power of the block 2(4) is recovered to 90%. However, the residual battery power of the block 2(9) is the second lowest after the block 2(4) and the residual battery power decrease ratio of the block 2(9) is the largest among all the blocks 2. Therefore, it can be seen that the charging to the battery 35 of the block 2(4) by the wireless power feeding cannot be sufficiently performed.

In this case, the start block 2S may start the wireless power feeding to the block 2(9) while maintaining the wireless power feeding route to the block 2(4). In this case, because the residual battery power of the battery 35 of the start block 2S is large, as explained above, the charging to the battery 35 of the start block 2S is kept stopped.

The block 2(6) also has the small residual battery power like the two blocks 2 explained above. Therefore, the wireless power feeding is performed in a wireless power feeding route of the start block 2S⇒the block 2(8)⇒the block 2(7)⇒the block 2(6). In this case, because the residual battery powers of the block 2(8) and the block 2(7) are relatively large, if battery charging to the respective blocks 2(8) and 2(7) is stopped as in the start block 2S, it is possible to more quickly perform charging to the battery 35 of the block 2(6).

With the wireless power feeding method explained above, in principle, all the batteries 35 can be maintained in the set range of 30% to 90% of the residual battery power. Therefore, it is possible to extend battery life. Note that in the block 2 to which the wireless power feeding is temporarily stopped, when charging to the battery 35 of the block 2 is necessary in the priority level, the charging to the battery 35 is started by the wireless power feeding.

Note that besides the method of performing the wireless power feeding to the blocks 2, in which the charging to the batteries is necessary, using the wireless power feeding route as explained above, by providing the DC/AC inverter 112 as shown in FIG. 38, it is possible to perform the wireless power feeding to the battery 35 of the block 2 having the small residual battery power from the battery 35 of the block 2 having the large residual battery power adjacent to the block 2. This is based on an instruction from the start block 2S to both the blocks 2.

On the basis of the instruction, the block 2 having the large residual battery power and the block 2 having the small residual battery power turn on the switches 23 of the blocks 2 corresponding to the side surface sections 3 adjacent to each other. Electric power of the battery 35 of the block 2 having the large residual battery power is supplied through the DC/AC inverter 112. An induced electromotive force is generated in the coil section for wireless power feeding 20 of the block 2 having the small residual battery power on the basis of an AC voltage generated in the coil section for wireless power feeding 20 of the battery 35 having the large residual battery power. Consequently, charging of the battery 35 of the block 2 having the small residual battery power can be performed.

(Blocks without the Display Sections)

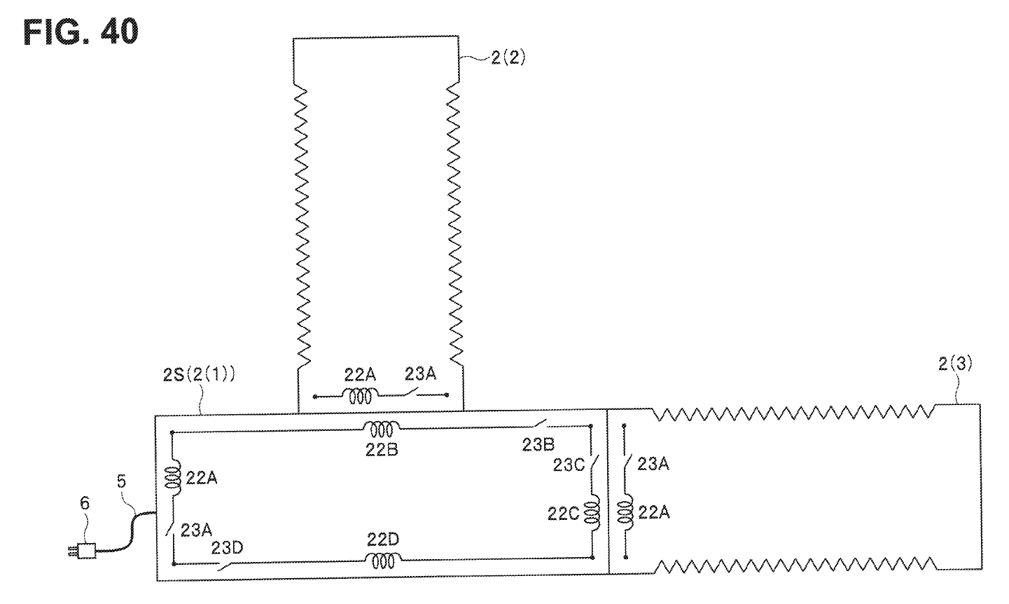

FIG. 40 is a diagram showing a state in Which blocks without the display sections 34 are coupled.

The respective blocks 2 configuring the display system 1 explained above respectively include the display sections 34. However, the start block 2S, the block 2(2), and the block 2(3) respectively do not include the display sections 34. Note that the block circuits configuring the systems of the respective blocks 2 are the same as the configuration explained above except that the display sections 34 are absent.

In such blocks 2, first, the housing shape of the start block 2S may be the rectangular parallelepiped shape explained above but may be other shapes, for example, a cylindrical shape.

In the block 2(2) and the block 2(3), parts of the housings are formed in a stretchable bellows shape. The coil 22A of the block 2(2) and the coil 22B of the start block 2S are coupled in an adjacent state. The coil 22A of the block 2(3) and the coil 22C of the start block 2S are coupled in an adjacent state.

An AC power supply is connected to the side surface section 3 on which the coil for wireless power feeding 22A of the start block 2S is disposed. Wireless power feeding to the other blocks 2(2) and 2(3) is performed in addition to power feeding to the start block 2S.

In the start block 2S, the four coils for wireless power feeding 22A to 22D are respectively formed with respect to the four surfaces. However, in the block 2(2) and the block 2(3), only one each of the coils for wireless power feeding 22B and 22A is disposed in each of the block 2(2) and the block 2(3).

In such a configuration of the respective blocks 2, for example, loads such as LED lights may be connected to and incorporated in the respective batteries 35 of the block 2(2) and the block 2(3). A load such as an LED light may be connected in series to the coil for wireless power feeding 22B of the block 2(2) without a load such as an LED light being connected to the battery 35. The same applies to the block 2(3). If electric power is supplied, by the wireless power feeding from the start block 2S, to the loads connected in series to the coils for wireless power feeding 22 of the blocks 2 coupled to the start block 2S, the batteries 35 are unnecessary in the blocks 2 (in this case, the block 2(2) and the block 2(3)) coupled to the start block 2S. Other circuits may be omitted according to an intended usage.

The block 2(2) and the block 2(3) are not inevitable stretchable in the bellows shape. Although not shown in FIG. 40, loads such as LEDs are incorporated in the two blocks 2. The LEDs can be caused to emit light by the wireless power feeding from the start block 2S.

For example, when it is desired to direct attention to only a specific flower among a variety of flowers present in a flower shop, it is possible to dispose, in a predetermined place, the start block 2S connected to the AC power supply, according to an instruction from the smartphone 7 to the start block 2S, cause the LEDs of the block 2(2) and the block 2(3) extending from the start block 2S to emit light, and irradiate a spotlight on only the specific flower.

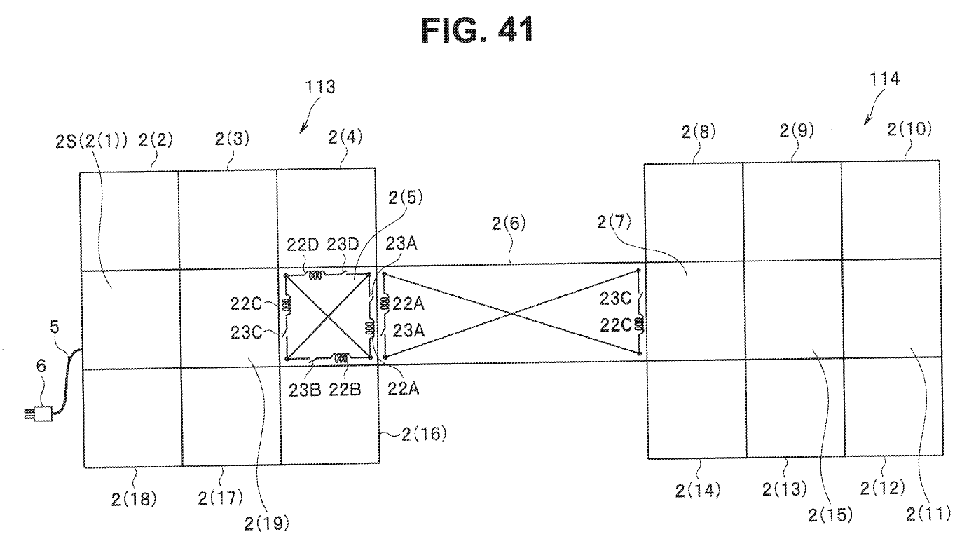

FIG. 41 is a diagram showing the display system 1 set in a certain site A113 and a display system 1 set in a site B114 apart from the site A113. Note that the coils for wireless power feeding of the respective blocks 2 not explained are not shown.

In this way, in a state in which a plurality of display systems 1 are present, when it is desired to perform wireless power feeding from the display system 1, to which an AC power supply of the site A113 is connected, to the display system 1 of the site B114 apart from the site A113, the display systems 1 are coupled by the block 2(6) without the display section 34.

In this case, if a wire of the wireless power feeding section 20 of the block 2(6) is replaced with a cable having a low power loss, a power loss in the block 2(6) can be reduced.

### (Disposition Search and Wireless Power Feeding by the Blocks not Including the Transmitting and Receiving Sections Including the Coils for NFC)

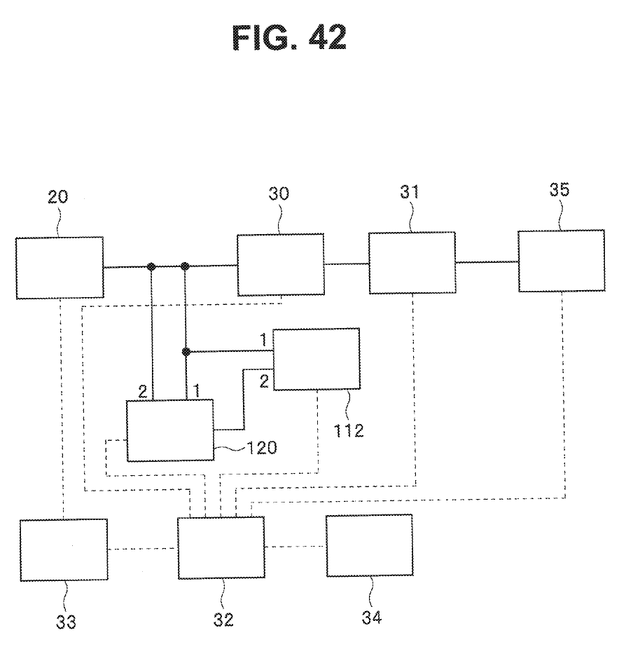

FIG. 42 is a diagram in which a modulator demodulator 120 is further added to the respective block circuits that perform wireless power feeding shown in FIG. 38. In a configuration shown in FIG. 42, the transmitting and receiving sections 40 including the coils for NFC 11 shown in. FIG. 6 are not provided. Therefore, the disposition search for the respective blocks 2 is performed using the coil sections for wireless power feeding 20 instead of the coils for NFC 11.

In this case, NFC communication from the smartphone 7 to the start block 2S cannot be performed. Therefore, the respective blocks 2 configuring the display system 1 always include the wireless communication sections 45 that perform short-distance communication such as WiFi.

A predetermined DC voltage is supplied to the DC/AC inverter 112 from either the AC/DC converter 30 or the battery 35 that supplies electric power necessary for system operation.

The DC/AC inverter 112 is controlled by the control section 32. An AC voltage having a predetermined frequency is output from an output terminal 1 of the DC/AC inverter 112 at necessary timing. Similarly, an AC voltage serving as a carrier wave fc having a predetermined frequency is output from an output terminal 2 and input to the modulator demodulator 120. Note that a function of the DC/AC inverter 112 may be added such that the AC voltage output from the output terminal 1 and the AC voltage output from the output terminal 2 have different frequencies.

The modulator demodulator 120 including a modulator and a demodulator outputs, from the output terminal 1 of the modulator demodulator 120, at necessary timing, for example, an amplitude modulated wave generated from the input carrier wave fc on the basis of a data signal fd input from the control section 32.

On the other hand, when an amplitude modulated wave from the adjacent block 2 is input to an input terminal 2 of the modulator demodulator 120 via the coil section for wireless power feeding 20, demodulation is performed in the modulator demodulator 120. The data signal fd input from the adjacent block 2 can be extracted.

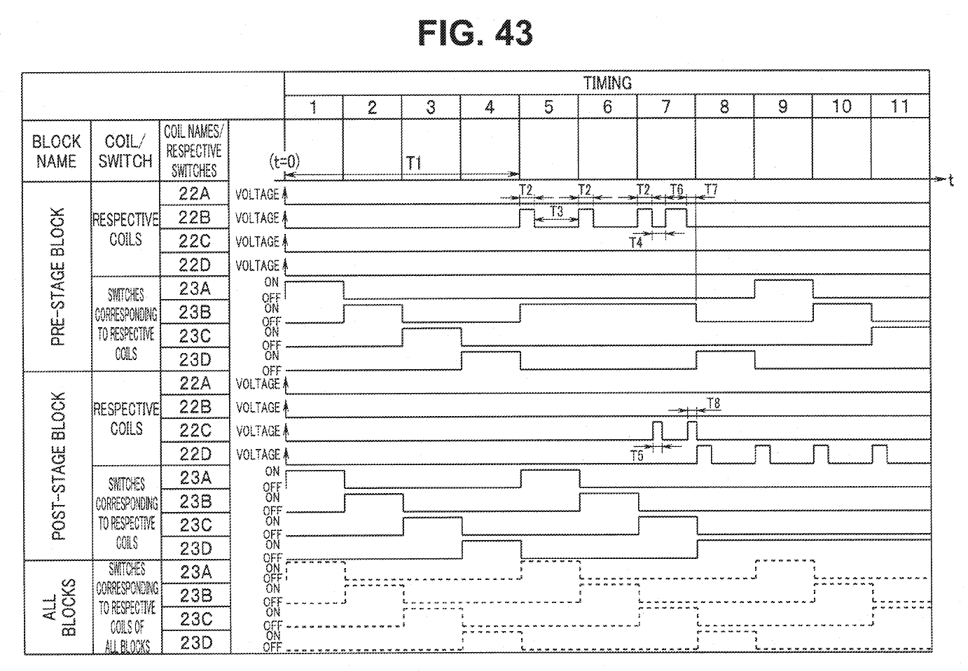

FIG. 43 is a timing chart for explaining the disposition search for the respective blocks 2 configuring the display system 1.

Items of a block name, a coil name, and a switch name exist on a left side of the timing chart of FIG. 43. As the block name, a pre-stage block, a post-stage block for performing next disposition search with respect to the pre-stage block, and all blocks including the pre-stage block and the post-stage block are described.

The coils for wireless power feeding 22A to 22D respectively set in the respective blocks 2 and the switches 23A to 23D respectively connected in series to the coils 22A to 22D are described.

A vertical axis of the timing chart has two parameters. A first parameter is an AC voltage applied to the coils. A second parameter is ON and OFF of the switches.

On the other hand, a parameter of a horizontal axis of the timing chart is time (t). Timing periods 1 to 11 same as one another and having a predetermined length are shown.

First, a flow of processing performed on the respective blocks 2 by the smartphone 7 is explained.

The smartphone 7 grasps, in advance, respective kinds of peculiar information (MAC addresses, manufacturing numbers, and the like) and attribute information (the various kinds of information and the like shown in FIG. 8) of the respective blocks 2 configuring the display system 1 and also grasps presence or absence of a socket, which is one kind of the attribute information (S200).

For example, with WiFi communication, first, the smartphone 7 requests the respective blocks 2 configuring the display system 1 to transmit a response from the blocks 2 having the socket 13, receives replies from the respective blocks 2, determines the start block 2S, and transmits block naming data “1” (the block 2(1)) to the block 2 functioning as the start block 2S (S201). Note that when sockets are present in a plurality of blocks 2, the smartphone 7 itself names any one of the blocks 2 as the start block 2S.

The smartphone 7 transmits a signal for synchronization with a clock of the smartphone 7 to the respective blocks 2 and instructs synchronization of clocks. Consequently, the clocks of the respective blocks 2 are synchronized with one another (S202).

After the clock synchronization of the respective blocks 2, the smartphone 7 instructs the respective blocks 2 to start the disposition search. The instruction includes an instruction for setting, as time t=0, a point in time when a predetermined number of clock pulses are counted from a point in time when the respective blocks 2 simultaneously receive the instruction. Note that in addition to the instruction, the smartphone 7 transmits, to the start block 2S, a value of a maximum number of corners of a polygon among the respective blocks 2 having polygonal shapes. For example, in FIG. 35, because all the blocks 2 are squares, the maximum number of corners is “4”. However, when the blocks 2 having different shapes such as a square and a pentagon are combined, data indicating the maximum number of corners of “5” is transmitted to the start block 2S. The start block 2S saves the data.

The disposition search is started from the block 2S (2(1)) at a point in time when t=0. At the same time, the respective control sections 32 of the respective blocks 2 (including the start block 2S) turn on, among the respective switches 23A to 23D shown in FIG. 35, the switch 23A first only in a period of the timing period 1 and subsequently turn on the switch 23B only in a period of the timing period 2. This is possible because the respective clocks of the respective blocks 2 are synchronized. Similarly, the control sections 32 turn on the switch 23C in the timing period 3 and turn on the switch 23D in the timing period 4. From a next timing period, the control sections 32 turn on the switch 23A, the switch 23B, the switch 23C, and the switch 23D in the order of respective timings. The order is repeated in principle. The repeating operation is performed until the disposition search of a forward path and a backward path starting from the start block 2S ends (S203).

The start block 2S (hereinafter referred to as pre-stage block), which starts the disposition search in step S203, starts approach to the adjacent block 2 when a period T1, which is a period set by the start block 2S (in this case, four timing periods), elapses from the time t=0.

The control section 32 of the start block 28 turns on the switch 23B simultaneously with a start of the timing period 5, outputs, from the terminal 1 of the modulator demodulator 120, a modulated wave (e.g., an amplitude modulated wave) obtained by superimposing an AC voltage output from the terminal 2 of the DC/AC converter 112 shown in FIG. 42 and the data fd output from the control section 32 including information that should be communicated from the pre-stage block to the post-stage block, and applies the modulated wave to the coil for wireless power feeding 22B of the coil section for wireless power feeding 20 in a period T2. On the other hand, the control section 32 of the block 2(2) (hereinafter referred to as post-stage block) turns on the switch 23A in the timing period 5 (S204).

Note that the switch 23B is turned on first rather than the switch 23A of the pre-stage block because, since a socket is set on the side surface section 3 corresponding to the coil 22A of the pre-stage block. Which is the start block 2S, as shown in FIG. 35, the control section 32 recognizes that the block 2 adjacent to the side surface section 3 corresponding to the coil 22A is absent.

When the period T2 in the timing period 5 (=the period T2+a period T3) elapses and, although not shown in FIG. 43, a next period T4 (the period T3>the period T4) elapses, the control section 32 of the pre-stage block determines that the post-stage block adjacent to the coil for wireless power feeding 22B is absent (S205).

The determination is made because, since the switch 23B is ON in the post-stage block in the period T2 as shown in FIG. 35, an induced electromotive force based on the modulated wave applied to the coil 22B of the pre-stage block is not generated in the coil 22A of the post-stage block. Therefore, because no information is communicated to the post-stage block, no response exists from the post-stage block to the pre-stage block in the period T4.

In the timing period 6 (−the period T2+the period T3), because the pre-stage block cannot confirm presence of the post-stage block, the control section 32 keeps the switch 23B ON. As explained above, the pre-stage block applies a modulated wave including the same data to the coil for wireless power feeding 22B only in the period T2 from the beginning. On the other hand, the post-stage block turns on the switch 23B in the next order in the timing period 6.

When the period T2 elapses and the next period T4 elapses, the control section 32 of the pre-stage block determines that the post-stage block adjacent to the coil 22B is absent as in the timing period 5 (S206).

In the timing period 7 (=the period T2+the period T4+a period T6+a period T7), the pre-stage block cannot confirm presence of the post-stage block yet. Therefore, the pre-sage block continues to keep the switch 23B of the pre-stage block ON. The pre-stage block apples the modulated wave to the coil 22B in the period T2. On the other hand, the post-stage block turns on the switch 23C in the next order in the timing period 6.

As shown in FIG. 35, as it is seen from the fact that the coil for wireless power feeding 22B of the pre-stage block and the coil for wireless power feeding 22C of the post-stage block are adjacent, an induced electromotive force based on the modulated wave applied to the coil for wireless power feeding 22B is generated in the coil for wireless power feeding 22C of the post-stage block. Therefore, the control section 32 demodulates, out of the induced electromotive force, via the modulator demodulator 120, the data fd output from the pre-stage block (S207).

In the period T5 in the next period T4 (the period T4≤the period T5), the post-stage block, which demodulates the data fd in the period T2, includes information concerning the post-stage block (including indication that a coil adjacent to the coil 22B of the pre-stage block is the coil 22C) in a modulated wave and applies the modulated wave to the coil for wireless power feeding 22C.

The pre-stage block demodulates, on the basis of the modulated wave applied to the coil for wireless power feeding 22C of the post-stage block, the data fd output from the post-stage block from the modulated wave, which is the induced electromotive force generated in the coil for wireless power feeding 22B, in the period T4 (S208).

The pre-stage block modulates the data fd (the path information string PIS), which should be communicated to the post-stage block for the disposition search, into a modulated wave and communicate the data fd to the post-stage block in the period T6. The post-stage block demodulates the data fd communicated from the pre-stage block in the period T6 (S209).

The post-stage block communicates a signal indicating that the path information string PIS from the pre-stage block is received to the pre-stage block in a period T8 in the period T7 (S210).

The pre-stage block, which receives the signal, turns off the switch 23B according to an end of the period T7 (S211).

Note that a switch turned on in a next timing period 8 of the pre-stage block is the switch 23D. This is because, although the switch 23C of the pre-stage block is ON in the timing periods 5 to 7, in the next timing period 8 after the switch 23C is turned off, the switch 23C is synchronized with turning-on of the switch 23D in common to the other all blocks.

In the respective steps explained above, the disposition search from the pre-stage block, which is the start block 2S, to the post-stage block, which is the block 2(2), ends, Consequently, the start block 2S, which has been the pre-stage block, is excluded from the target of the disposition search. The block 2(2), which has been the post-stage block, is set as the pre-stage block this time. An unsearched block is set as the post-stage block with respect to the pre-stage block. The disposition search is performed between the two blocks 2.

Subsequently, steps in the timing periods 8 to 11 of the timing chart are briefly explained.

Because the disposition search in the cod 22C ends, the block 2(2) set as the pre-stage block performs, as the next order, determination of presence or absence of an adjacent block in the coil for wireless power feeding 22D and, if the block is present, performs exchange of information with the adjacent block. However, in the timing periods 8 to 11 of the timing chart, no response to the modulated wave applied to the coil for wireless power feeding 22D is received from an unsearched post-stage block at all four times. Therefore, the control section 32 determines that the adjacent block 2 is absent on the coil 22D side. Note that as a premise, all the polygonal shapes of the blocks 2 configuring the display system 1 are the squares. First, the smartphone 7 inquires the respective blocks 2 which polygonal shapes the blocks 2 have. A largest value among responses from the respective blocks 2 is set as the number of times of modulated wave application from the pre-stage block to the unsearched post-stage block explained above. Therefore, for example, if at least one block 2 is hexagonal and all the remaining blocks 2 are square among the blocks 2 configuring the display system 1, it is unknown whether the unsearched block, which is the post-stage block, is square or hexagonal. Therefore, the pre-stage block always needs to apply the modulated wave six times.

Explanation of the disposition search using the timing chart of the remaining respective blocks 2 shown in FIG. 35 is omitted. However, by performing the series of steps explained above, it is possible to perform the disposition search of the forward path from the block 2(3) to the block 2(9) and subsequently perform the disposition search of the backward path from the block 2(9) to the start block 2S. Consequently, the same information as the path information string PIS shown in FIG. 29 can be collected. The respective blocks confirm the data. Consequently, it is possible to perform wireless power feeding from the start block 2S to the other blocks 2.

### (Using WiFi Incorporated in the Blocks for Wireless Power Feeding as an Access Point or a Station)

When the respective blocks 2 have a wireless LAN function (WiFi, etc.), if the number of the respective blocks 2 configuring the display system 1 is small, the smartphone 7 can be set as a base state or an access point (hereinafter referred to as AP), the respective blocks 2 can be set as stations or terminals hereinafter referred to as STA), and the respective blocks 2 can be connected to the smartphone 7 by the WiFi or the like.

However, when a total number of the respective blocks 2 increases to a certain degree, the total number exceeds a maximum number of coveted terminals of the AP of the smartphone 7. A block 2 that cannot be connected to the smartphone 7 by the WiFi or the like may be occurred.

Therefore, when the total number of the blocks 2 exceeds a maximum number of connected blocks of the AP of the smartphone 7, the following two countermeasures arc conceivable.

As a first countermeasure, for example, the start block 2S during the disposition search, which receives an instruction from the smartphone 7, switches the WiFi to an STA and AP mode. The STA of the start block 2S is kept connected to the AP of the smartphone 7.

The start block 2S notifies completion of the switching and an ESSID (extended service set identifier) of the AP to an application for control (hereinafter referred to as control application) of the smartphone 7 (or the AP of the smartphone 7 may detect a beacon of an AP of the start block 2S and detect completion of the mode switching).

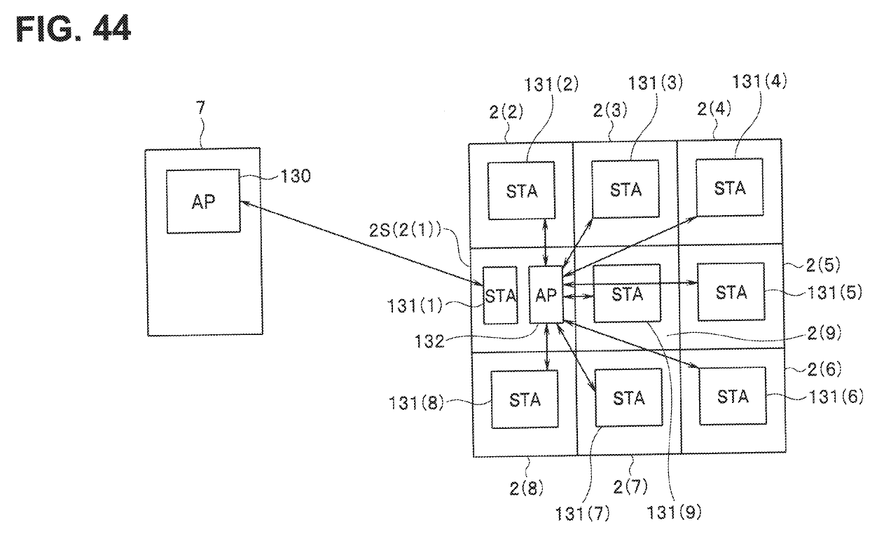

FIG. 44 shows the smartphone 7 and the respective blocks 2 configuring the display system 1.

In the start block 2S, the WiFi is switched to the STA and the AP mode.

In the beginning, STAs 131(1) to 131(9) of the respective blocks 2 are set to be connected to the AP of the smartphone 7. However, a part of the respective blocks 2 is sometimes unconnected.

Therefore, the control application of the smartphone 7 instructs the connected respective blocks 2 (excluding a dual mode operation) to disconnect the blocks 2 from an AP 130 of the smartphone 7 and connect the blocks 2 to an AP 132 of the start block 2S. Consequently, the total number of the blocks 2 is smaller than the maximum number of connected terminals of the AP of the smartphone 7. Therefore, the unconnected blocks 2 are once connected to the AP 130 of the smartphone 7 one after another and are switched to connection to the AP 132 of the start block 2S. By repeating this, the STA 131(2) to the STA 131(9) of the respective blocks 2(2) to 2(9) are connected to the AP 132 of the start block 2S. The STA 131(1) of the same start block 2S is connected to the AP 130 of the smartphone 7. Consequently, the unconnected blocks can be eliminated.

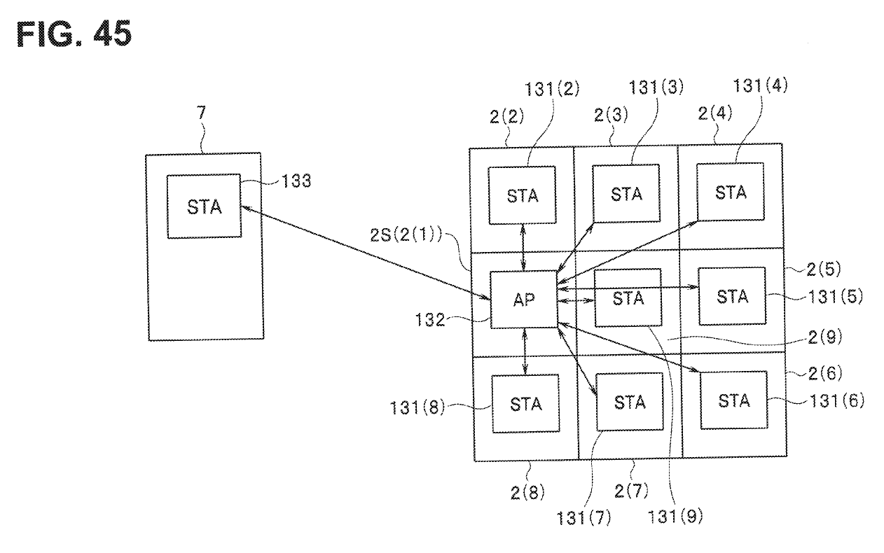

As a second countermeasure, the smartphone 7 and the respective blocks 2 configuring the display system 1 in FIG. 45 are shown. A difference from FIG. 44 is that, at an initial stage, for example, the WiFi of the start block 2S is set as the AP 132 and the other blocks 2 and the smartphone 7 are set as the STAs 131(2) to 131(9) and a STA 133. In such a method, when the total number of the blocks 2 increases, it is possible to eliminate possibility that the smartphone 7 are not connected to all the blocks 2.

A method of grasping the residual battery powers shown in FIG. 39 in the blocks 2 in which the coils for NFC 11 are disposed on the side surface section 3 sides, the blocks 2 in which the coils for NFC 11 are not disposed on the side surface section 3 sides, and the blocks 2 having the WiFi function is summarized and explained.

As shown in FIG. 35, when the coils for NFC 11 are present in the respective blocks 2, the start block 2S can grasp the residual battery powers of the other blocks 2 using the transmitting and receiving sections 40 of the blocks 2 including the coils for NFC 11.

When coils for NFC are absent in the respective blocks 2, for example, if the method explained above for applying the modulated wave including the data fd to the blocks 2 to which wireless power feeding is not performed is performed, the start block 2S can grasp the residual battery powers of the battery 35 of the other blocks 2.

When the respective blocks 2 have the WiFi function, if the smartphone 7 instructs the respective blocks 2 to transfer the residual battery powers, the smartphone 7 can receive the residual battery powers from the respective blocks 2. If the smartphone 7 transfers the residual battery powers to the start block 2S, the start block 2S can grasp the residual battery powers.

When the respective blocks 2 have the WiFi function and the start block further have both functions of the AP and the STA, if the start block 2S instructs the respective blocks 2 to transfer the residual battery powers, the start block 2S can grasp the residual battery powers transferred from the respective blocks 2.

The start block 2S may grasp the battery residual powers according to the respective types and perform the wireless power feeding to the blocks 2 that need the wireless power feeding.

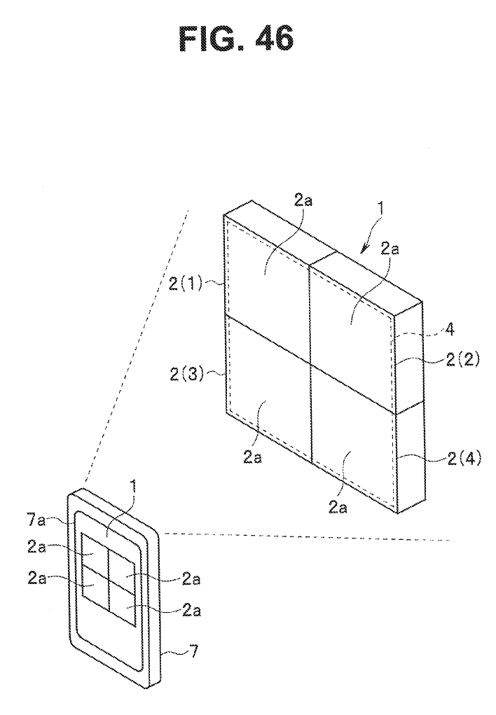

In the display system 1 configured by the respective blocks 2 including only the coils for wireless power feeding 22A to 22D on the respective side surface sections 3 shown in FIG. 35 and having the WiFi function, a disposition searching method different from the disposition searching method explained referring to FIG. 43 is explained below referring to FIG. 46.

FIG. 46 shows a state in which a person (not shown in FIG. 46) holding the smartphone 7 and the display system 1 configured by the plurality of blocks 2 are opposed to each other.

The display surface 1a of the display system 1 is configured by the display surfaces 2a of the respective blocks 2. On the other hand, an image obtained by photographing the display system 1 is displayed on the display surface 7a of the smartphone 7.

As explained above, it is assumed that the smartphone 7 acquires the peculiar identification information and the attribute information from each of the respective blocks 2 in advance. On that premise, first, the smartphone 7 instructs the respective control sections 32 of the respective blocks 2 not configuring the display system 1 to display, for example, white lines in, for example, positions close to the coils for wireless power feeding 22A of the display sections 34.

In response to the instruction, the respective blocks 2 display the white lines in the positions of the respective display sections 34.

When configuring the display system 1 with the respective blocks 2, the user configures the display system 1 by disposing all the blocks 2 such that display positions of the white lines of the display sections 34 of the respective blocks 2 are always on upper sides of the display sections 34 of the respective blocks 2 when viewed from the user. Note that at the point in time, the respective blocks 2 do not recognize that the respective blocks 2 are respectively blocks named as the blocks 2(1) to 2(4) as shown in. FIG. 46.

The smartphone 7 creates and saves a data table that associates respective codes of MAC addresses and the like, which are respective kinds of peculiar identification information, acquired from the respective blocks 2, and different color codes respectively associated with the respective codes (because the number of blocks is four, the color codes are, for example, red, yellow, green, and blue).

The smartphone 7 transmits data of the data table to the respective blocks 2.

The respective blocks 2 display colors corresponding to the respective display sections 34 from the received data on the basis of the color codes corresponding to the peculiar identification information of the blocks 2 (e.g., it is assumed that a block on an upper left is displayed in blue, a block on an upper right is displayed in yellow, a block on a lower left is displayed in red, and a block on a lower right is displayed in green in the display system 1).

The user photographs, with the smartphone 7, as shown in FIG. 46, the display system 1 configured by the respective blocks 2 displayed on the respective display sections 34 having the different colors one another and causes the smartphone 7 to display an image of the display system 1 on the display surface 7a of the smartphone 7.

The control section 50 of the smartphone 7 specifics, in a pixel coordinate of the image displayed on the display surface 7a, four colors (corresponding to the numbers of blocks) in descending order of numbers of pixels corresponding to the number of the blocks of four and coordinates of regions divided by the colors (S305).

On the display surface 7a of the smartphone 7, because a color of a section on an upper left side is blue, the control section 32 names the region marked off by blue as the block 2(1). Similarly, the control section 32 names a section on an upper right as the block 2(2) with yellow, names a section on a lower left side as the block 2(3) with red, and names a section on a lower right side as the block 2(4) with green and adds data of these blocks in the data table as new items.

The smartphone 7 transfers the data of the data table to the respective blocks 2.

The respective blocks 2 recognize, from the colors respectively displayed by the blocks 2 and the table data, which blocks among the blocks 2(1) to 2(4) named by the smartphone 7 the blocks 2 are and save the information concerning the blocks (S307).

The smartphone 7 displays, on the display surface 7a, an image desired to be displayed on the display system 1, divides the image into four, associates the blocks 2(1) to 2(4) with respective divided image data, and transfers the divided image data to the respective blocks 2(1) to 2(4).

The respective blocks 2(1) to 2(4) display images on the respective display sections 34 on the basis of data in which the respective divided image data and the blocks 2(1) to 2(4) are associated.

As explained above, according to the embodiment explained above, it is possible to perform the wireless power feeding from any block 2 to the blocks 2 adjacent to the block 2 and adjacent to one another.

A data communication method of the respective transmitting and receiving sections of the blocks 2 may be optical communication or the like instead of the proximity wireless communication such as the NFC. In that case, the respective transmitting and receiving sections are, for example, mechanisms for performing data communication using infrared rays. The infrared rays are transmitted through center regions of the respective side surface sections of the, blocks.

When necessity for increasing or reducing sizes of blocks or necessity for more quickly transferring large data arises, optimum communication means corresponding to the necessity may be selected.

The wireless power feeding based on the premise that the side surface sections 3 of the adjacent blocks 2 are right opposed to each other is explained above. In the following explanation, a structure of the side surface section 3 adaptable when the side surface sections 3 are not always right opposed to each other is explained.

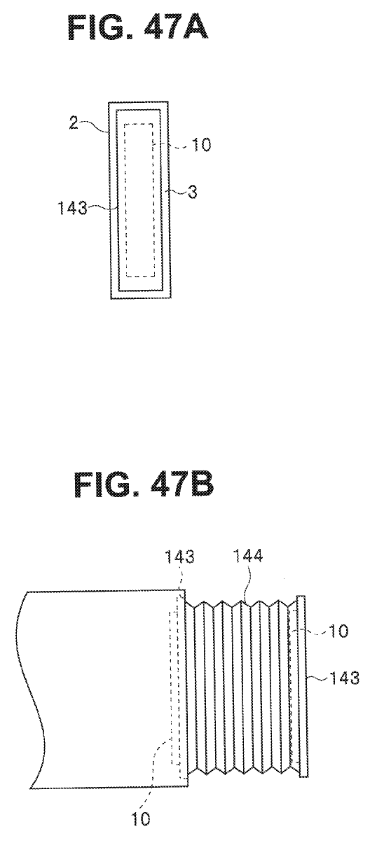

FIG. 47A shows a structure including a lid section 143 anew on the side surface section 3 of the block 2. The coil for wireless power feeding 22 is disposed on a rear side of the lid section 143 as indicated by a dotted line. Note that the lid section 143 is usually flush with the side surface section 3.

FIG. 47B shows a state in which the lid section 143 is drawn out from the side surface section 3. A bellows-like material 144 (all four surfaces of which are bellows) is connected to the rear surface of the lid section 143. The other end of the bellows-like material is fixed in a predetermined part (not shown in FIG. 47B) inside the block 2.

A mechanism is formed in which, when the lid sections 143 disposed on the side surface sections 3 of the adjacent blocks 2 are drawn out and overlap, the lid sections 143 are coupled.

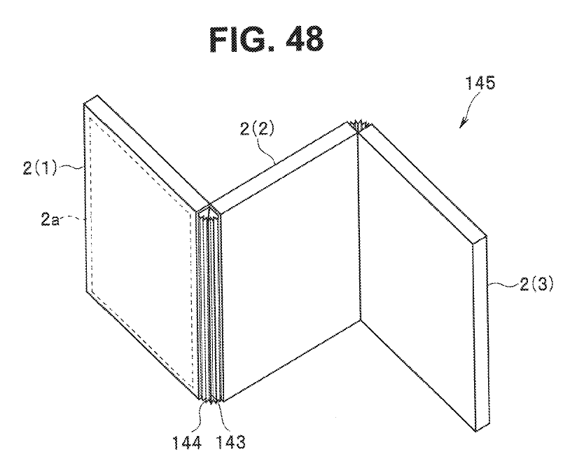

FIG. 48 shows a folding screen 145 (or a partitioning screen) configured by drawing out necessary lid sections 143 in the lid sections 143 disposed on the respective side surface sections 3 of the respective blocks 2 when the wireless power feeding to the three blocks 2(1) to 2(3) is performed.

In the block 2(1) and the block 2(2), the lid sections 143 drawn out from the block 2(1) and the block 2(2) are coupled. The bellows-like materials 144 of the block 2(1) and the block 2(2) are further drawn out. In the block 2(2) and the block 2(3), the lid sections 143 drawn out from the block 2(2) and the block 2(3) are coupled. The bellows-like materials 144 of the block 2(2) and the block 2(3) are further drawn out.

Because such a structure is added to the blocks 2, the blocks 2 can be disposed in pillars and the like having a predetermined curvature radius besides the folding screen 145.

Because the lid sections 143 are coupled in this way, it is possible to reduce a loss of power transfer in the wireless power feeding.

Note that naturally the coil for NFC 11 for the short-distance wireless communication may be disposed on a back of the lid section 143 in addition to the coil for wireless power feeding 10.

### (Action)

In view of a result of prior disposition search for the respective blocks 2, the wireless power feeding can be performed from the pre-stage block to the post-stage block for example, on the basis of electric power supplied from a 100 V AC power supply. The systems of the respective blocks 2 can be continuously operated by the wireless power feeding.

While certain embodiments have been described., these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless power feeding device comprising:
a coil section for wireless power feeding including, as pairs, coils for wireless power feeding provided on at least two side surface section sides of the wireless power feeding device and switches connected in series to the coils for wireless power feeding, at least two of the pairs being connected in parallel;
a power supply section connected to the coil section for wireless power feeding and for causing the wireless power feeding device to operate;
a switching section for performing switching of ON and OFF of the respective switches; and
a control section configured to perform control for wireless power feeding of the wireless power feeding device.

2. The wireless power feeding device according to claim 1, further comprising at least two transmitting and receiving sections for transferring image data and the like.

3. The wireless power feeding device according to claim 2, wherein coils for proximity wireless communication included in the transmitting and receiving sections and the coils for wireless power feeding are disposed side by side on the side surface section sides.

4. The wireless power feeding device according to claim 1, wherein the wireless power feeding device includes, on any one of a plurality of surfaces, a socket connected to an AC power supply.

5. The wireless power feeding device according to claim 1, further comprising a wireless communication section by a wireless LAN.

6. The wireless power feeding device according to claim 1, further comprising a display section.

7. The wireless power feeding device according to claim 1, wherein one of the coils for wireless power feeding is disposed not to exert influence of the wireless power feeding on another of the coils for wireless power feeding.

8. A wireless power feeding system comprising the wireless power feeding device according to claim 1 in plurality.

9. A wireless power feeding system comprising a first wireless power feeding device and a second wireless power feeding device, the first wireless power feeding device being the wireless power feeding device according to claim 1, wherein
the second wireless power feeding device includes:
a coil section for wireless power feeding including, as pairs, coils for wireless power feeding provided on one or more side surface section sides and switches connected in series to the coils for wires power feeding;
a load section connected in parallel to the coil section for wireless power feeding;
a power supply section connected to the coil section for wireless power feeding and for causing the wireless power feeding device to operate;
a switching section for performing switching of ON and OFF of the respective switches; and
a control section configured to perform control for wireless power feeding of the wireless power feeding device.
